(19) United States
(12) Patent Application Publication
(10) Pub. No.: US 2012/0022885 A1
(43) Pub. Date: Jan. 26, 2012

(54) Treatment Support System for Emergency Patients

(75) Inventors: Yuichi MURAYAMA, Shibuya-ku (JP); Hiroyuki TAKAO, Shibuya-ku (JP)

(73) Assignee: TRYFOR CO., LTD., Tokyo (JP)

(21) Appl. No.: 13/008,769

(22) Filed: Jan. 18, 2011

(30) Foreign Application Priority Data
Jul. 20, 2010 (JP) 2010-163454

(51) Int. Cl. G06Q 50/00; G06Q 10/00

(52) U.S. Cl. 705/2

(57) ABSTRACT

This application discloses a treatment support system making it easy for a physician in charge to ask another specialist physician, especially another expert physician, for an opinion. The support system is much useful in providing an optimal treatment for an emergency disease, reviewing an expert-physician's opinion. The support system comprises a database server including an expert-physician database file in which information of expert-physicians belonging to institutions other than the hospital is recorded, a primary terminal handled by a physician in charge of treating the emergency patient in the hospital, secondary terminals handled by expert-physicians, a primary transmitter for transmitting an initial disease data to each secondary terminal, a received information displayer to display the initial disease data on each secondary terminal, a secondary transmitter to transmit an opinion to the primary terminal, an opinion displayer to display the opinion on the primary terminal, and an alarmer to generate an alarm by sound, light, vibration or any combination thereof to each expert-physician when the initial disease data is transmitted to each secondary terminal. The initial disease data includes a disease image of the emergency patient and time when the image was taken. The opinion is concerning to necessity of an additional test and investigation for the emergency patient, a diagnosis for the emergency patient, or a treatment plan for the emergency patient. The primary transmitter transmits the initial disease data with a time period for transmitting the opinion.

### BACKGROUND OF THE INVENTION

1. Field of the Invention

This invention relates to a treatment support system for emergency patients in a hospital.

2. Description of the Related Art

Eye-opening innovations have been appearing in medical scenes. Many high-tech medical instruments such as MRI and CT equipment are used for diagnosis of broad range of diseases. Application of IT (information technology) has been also rapidly advancing. For example, medical information transfer via a network to remote medical service providers has been proposed, as well as computerized diagnosis where a disease name is presumed by a computer to which information about a patient's condition is input. One of those techniques is disclosed in Japanese Publication No. 2004-280807.

However, utilization of IT in medical scenes has been insufficient for treatments of diseases, particularly for treatments of emergency patients in serious condition. In treating an emergency patient, a diagnosis and decision of a treatment plan must be done shortly after the patient has arrived to the hospital by an ambulance. An investigation and test are often required for the diagnosis. Depending on the result thereof, additional ones are sometimes required.

One particular problem in treating an emergency patient is that diagnosis cannot be established immediately. For example, a head X-ray, CT and MRI scans are carried out initially for an emergency patient complaining of headache. However, it is often impossible to establish the diagnosis from those diagnostic images. In cerebrovascular diseases particularly, sometimes it cannot be judged whether it is a cerebral infarction or hemorrhage. Even if the disease is identified, it is often difficult to decide immediately what is the best treatment option for it. For a cerebral aneurysm such as subarachnoid hemorrhage, for example, there are two treatment options: clipping and coiling. In clipping, the neck of the aneurysm is obliterated by a clip, while in coiling, a catheter is inserted into the artery carrying the lesion and the aneurysm is filled inside with specially designed coils. From a diagnostic image, it is sometimes impossible to judge which option is better.

As known, on the other hand, the survival rate of cerebrovascular disease patients would decrease more and more, when it takes a longer time from onset of disease to initiation of treatment and surgery. It is necessary that diagnosis and treatment are done in a quite short period. In ischemic stroke, for example, it was reported that the rehabilitation rate was 30 to 40% if tPA (tissue Plasminogen Activator) was administered within three hours from the occurrence, although the rate dropped off sharply if it was over three hours (Moira K. Kapral et al., Registry of the Canadian Stroke Network Progress Report 2001-2005). In such emergency medical situations as described, physicians are making decisions and performing treatments, considering them the best, relying only on their own knowledge and experience, in the battles against time.

In treating an emergency disease, however, sometimes it would be better to request an opinion of another physician specialized in the field of the disease in consideration to obtain an optimal treatment result, not relying only on decision made by the emergency physician in charge. In this case, if the other physician is on duty in the hospital, it is possible to ask him/her directly for an opinion, showing the diagnostic images. However, that is impossible if no other specialist physician is on duty in the hospital. Even there may be the case that no specialist physician in the field of the presumed disease belongs to the hospital. In such cases, there is no other way but relying solely on the knowledge of the physician in charge.

The above description is upon the premise that the physician in charge is specialized in the field of the disease. In emergency medical scenes, however, a not specialized physician often has to attend an emergency patient. For example, when a patient having a cardiovascular disease is brought to a hospital by an ambulance, it could happen that only a physician specialized in gastroenterology is on duty. In hospitals and clinics in depopulated or remote rural areas, moreover, only a physician without specialization in any medical field, the so-called “general physicians”, might be on duty. In this case, it is impossible to carry out diagnosis and treatment requiring a highly specialized judgment. In this case, because the patient cannot be treated in the medical facility, the ambulance must transfer the patient to another medical facility. In such a case, the problem of so-called “tarai-mawashi”, meaning that an emergency patient in an ambulance is rejected admission by one hospital after another, could happen.

Furthermore, even in a hospital with higher level of specialization, in which a specialist physician is always on duty, it is sometimes difficult for him/her to establish the diagnosis alone for a rare condition. Even if the diagnosis is established by his/her own knowledge and experience, sometimes it would be better to have another specialist physician's opinion. Actually, physicians manage emergences only on their own because of time constraint.

To have another physician's opinion about a disease has been done so far. A physician often tells a patient to see another physician, writing a referral letter. A patient him/herself often asks another physician for an opinion, i.e., second opinion. However, those are other-opinion requests via patients, not being that a primary physician in charge asks directly another physician for an opinion. In emergency medical situations as described, on the other hand, it is frequently desired by a physician in charge to ask another specialist physician for an opinion directly.

### SUMMARY OF THE INVENTION

This invention was made considering the above problems in emergency medical services, and presents a treatment support system making it easy for a physician in charge to ask another specialist physician, especially another expert physician, for an opinion. The support system by this invention is much useful in providing an optimal treatment for an emergency disease, reviewing an expert-physician's opinion.

To accomplish the object, the invention presents a support system for a treatment of an emergency patient in a hospital, comprising

a database server including an expert-physician database file in which information of expert-physicians belonging to institutions other than the hospital is recorded, the expert-physicians being recognized as those having special knowledge and experience in specific clinical fields of diseases;

a recorder to record the information of the expert-physicians in the expert-physician database file;

a primary terminal handled by a physician in charge of treating the emergency patient in the hospital;

each secondary terminal handled by each expert-physician, the information recorded in the expert-physician database file including addresses of the secondary terminals;

a primary transmitter for transmitting an initial disease data to each secondary terminal, the initial disease data including a disease image of the emergency patient and time when the image was taken;

a received information displayer to display the initial disease data on each secondary terminal after the initial disease data is received thereon;

a secondary transmitter to transmit an opinion to the primary terminal, the opinion being input by one of the expert-physicians on one of the primary terminals;

an opinion displayer to display the opinion on the primary terminal after the opinion is received thereon, and

an alarmer to generate an alarm by sound, light, vibration or any combination thereof to each expert-physician when the initial disease data is transmitted to each secondary terminal.

In the invention, the opinion is concerning to necessity of an additional test and investigation for the emergency patient, a diagnosis for the emergency patient, or a treatment plan for the emergency patient, and the primary transmitter transmits the initial disease data with a time period for transmitting the opinion.

### BRIEF DESCRIPTION OF DRAWINGS

FIG. 1 roughly shows a treatment support system as the embodiment of the invention.

FIG. 2 roughly shows the work flow of an emergency patient care utilizing the support system of this embodiment.

FIG. 3 roughly shows an example structure of EP-DBF.

FIG. 4 roughly shows an example structure of the temporary case DBF.

FIG. 5 roughly shows an example structure of the temporary receiver DBF.

FIG. 6 roughly shows an example of the menu form in the support project.

FIG. 7 roughly shows an example of the inquiry information input form.

FIG. 8 roughly shows an example of the inquiry information transmission form.

FIG. 9 is a schematic flowchart of the inquiry transmission program.

FIG. 10 roughly shows an example of the inquiry E-mail displayed on a secondary terminal 2.

FIG. 11 roughly shows an example of the availability mail transmitted by the availability information transmission program.

FIG. 12 roughly shows an example of the initial disease data transmission form.

FIG. 13 roughly shows an example of the initial disease data mail received at a secondary terminal 2.

FIG. 14 roughly shows a status after clicking the image browsing button 41 in FIG. 13.

FIG. 15 roughly shows an example status of the secondary terminal 2 when the image restructuring button 43 is clicked.

FIG. 16 schematically shows, for example, a status after the command button “rotation” on FIG. 15 is clicked.

FIG. 17 roughly shows an example of the opinion transmission form.

FIG. 18 roughly shows the flow chart of the secondary transmission program in this embodiment.

FIG. 19 roughly shows an example of the opinion mail displayed on a primary terminal 1.

FIG. 20 roughly shows an example of the inquiry result displaying form.

FIG. 21 roughly shows an example of the integrated answer displaying form displayed on the primary terminal 1.

FIG. 22 roughly shows an example of the image capturing form.

FIG. 23 roughly shows an example of the initial disease data transmission form in which the image file information is captured.

FIG. 24 roughly shows a flow chart of the batch-type initial transmission program.

FIG. 25 roughly shows an example of the opinion presence displaying form.

FIG. 26 roughly shows an example of the integrated opinion displaying form.

FIG. 27 roughly shows an example status when the details button 56 is clicked in FIG. 26.

FIG. 28 roughly shows an example of the opinion mail automatically forwarded by the real-time communicator.

FIG. 29 roughly shows an example of the progress information reminder mail received on a secondary terminal 2.

FIG. 30 roughly shows an example of the progress information displaying form received at a secondary terminal 2.

### PREFERRED EMBODIMENT OF THE INVENTION

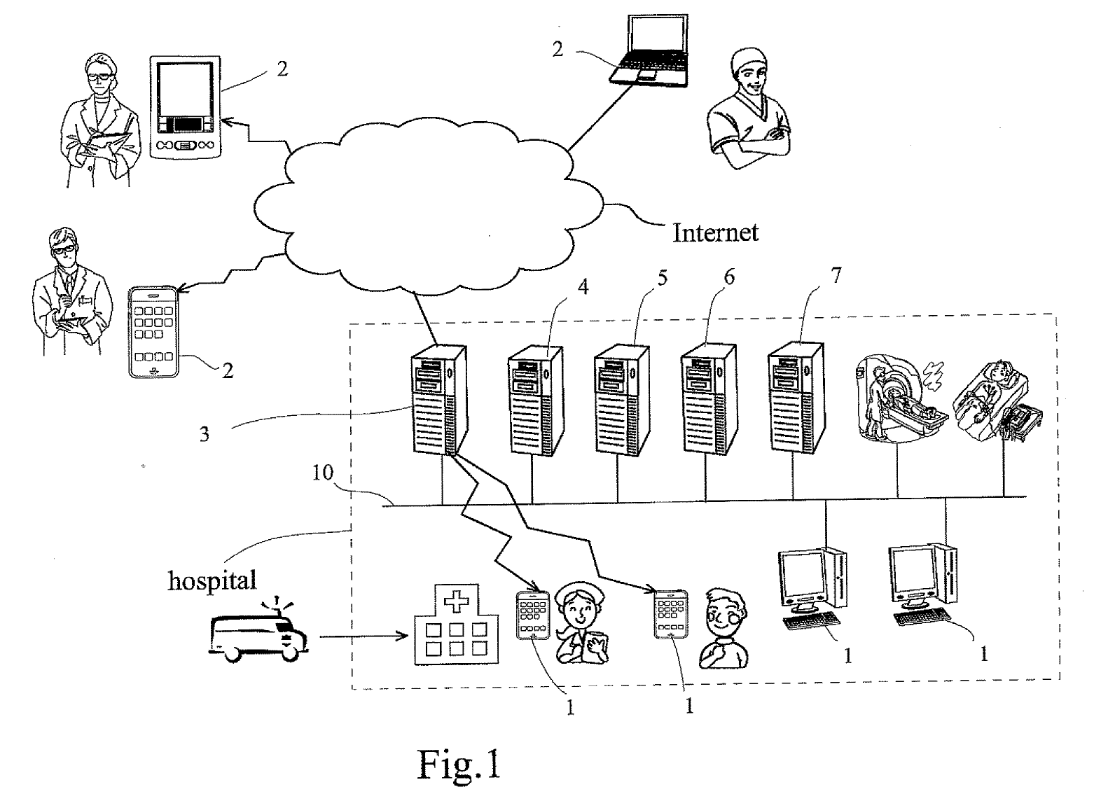

A preferred embodiment of the invention will be described as follows. FIG. 1 roughly shows a treatment support system as the embodiment of the invention. The support system shown in FIG. 1 comprises a primary terminal 1 handled by a person in charge in a hospital where an emergency patient is admitted, secondary terminals 2 handled by physicians who are experts in the field of the emergency disease. The system supports the treatment of the emergency disease by communication between the primary terminal 1 and secondary terminals 2 via a network such as the Internet.

Although the hospital is usually designated as emergency medical facility, application of the invention is not limited only to such facilities, because an emergency patient could be occasionally admitted to a hospital not designated as emergency medical facility. The support system described below is suitable especially for treating a serious disease such as cerebrovascular diseases. The hospital is supposed to be able to admit such a serious emergency patient. Nevertheless, its use is not limited only to such hospitals.

In the following description, “terminal” means a computer capable of inputting, outputting, transmitting and receiving information via the network, and displaying the received information, and is typically a personal computer, cell phone, PDA (personal data assistant) or the like. A cell phone can be so called smart phone. “Person in charge” handling the primary terminal 1 is typically a physician in charge of treating an emergency patient. Nevertheless, “person in charge” could be another person than the physician in charge, e.g., a nurse, assistant, secretary, clerk or the like, because these persons could handle the primary terminal 1 according to the instruction by the physician in charge.

“Expert-physicians” means physicians recognized as having high-level special knowledge and experience in a specific medical field. “Experience” in this could be experience of diagnosis, experience of treatment, or the both.

Currently each academic society in each medical field qualifies a physician having special knowledge, skill and experience as “specialist physician”. A physician can initially become a “board certified specialist” after certification by an academic society or the appropriate national Board for a certain medical field. And then the physician can become a sub-specialist in a certain more narrow area of medical knowledge and practice after the required training, apprenticeships, examination and so on.

“Expert-physicians” in this embodiment are those having specialties higher than the above-described “sub-specialist”. More specifically, they are assumed to be teaching physicians or physicians on a similar level. “Teaching physicians” generally mean physicians having knowledge, skill and experience of higher levels than board certified physicians and sub-specialist physicians, and are in positions to teach even board-certified specialists. In this embodiment, physicians on the same level as the teaching physicians or on a higher level are assumed as expert-physicians. The expert-physicians in this embodiment are the partners who provide opinions as described later. What level of knowledge, skill and experience is required for the expert-physicians to participate may be decided adequately depending on situations. Therefore, even physicians at lower levels than the teaching physicians may be asked for the opinions.

The support system of this embodiment comprises a group of servers in addition to the primary terminal 1 and secondary terminals 2. The primary terminals 1 and the servers are provided on an intranet 10. The intranet 10 is connected to the Internet via a firewall (not shown) to prevent unauthorized accesses.

One of the servers is a communication server 3 acting as a communication agent between the primary terminals 1 and secondary terminals 2. Another one of the servers is a database server 4 managing database files including an expert-physicians database file (hereinafter shortly, “EP-DBF”). As other servers, a recording server 5, PACS server 6 and electronic chart server 7 are provided on the intranet 10. These servers may be provided individually. Otherwise one computer server may provide two or more server functions. In the latter case, more than one server programs are installed to one server computer in a way to play two or more different server roles.

A number of primary terminals 1 are provided for a number of hospital staff members. Each primary terminal 1 may be a desktop or notebook computer, workstation, or a mobile type such as cell phone or PDA. The computers as primary terminals 1 are connected to the intranet 10 via a wired LAN interface. Although mobile type terminals as primary terminals 1 are connected to the intranet 10 usually via a public wireless network and the Internet, those may be connected directly to the intranet 10 via a private wireless network provided in the hospital.

The hospital is equipped with a variety of equipment for tests and investigations. Some of them output images as results, such as X-ray images, CT and MR', which are hereinafter called “imaging equipment”. Although the images are often taken at diseased parts of patients, those may be at other parts related to diseases. The images are referred as “disease images” or “diagnostic images” in this specification.

A PACS (picture archiving communication system) is provided on the intranet 10, including the PACS server 6. Each primary terminal 1 can capture an image data in the PACS server 6 via the intranet 10. Moreover, an electronic chart system, which includes the electronic chart server 7, is provided on the intranet 10. Electronic chart data in the electronic chart server 7 can be acquired at each primary terminal 1 via the intranet 10 as well. Such a PACS system and electronic chart system can be available from some medical system providers. Therefore, detailed description is omitted.

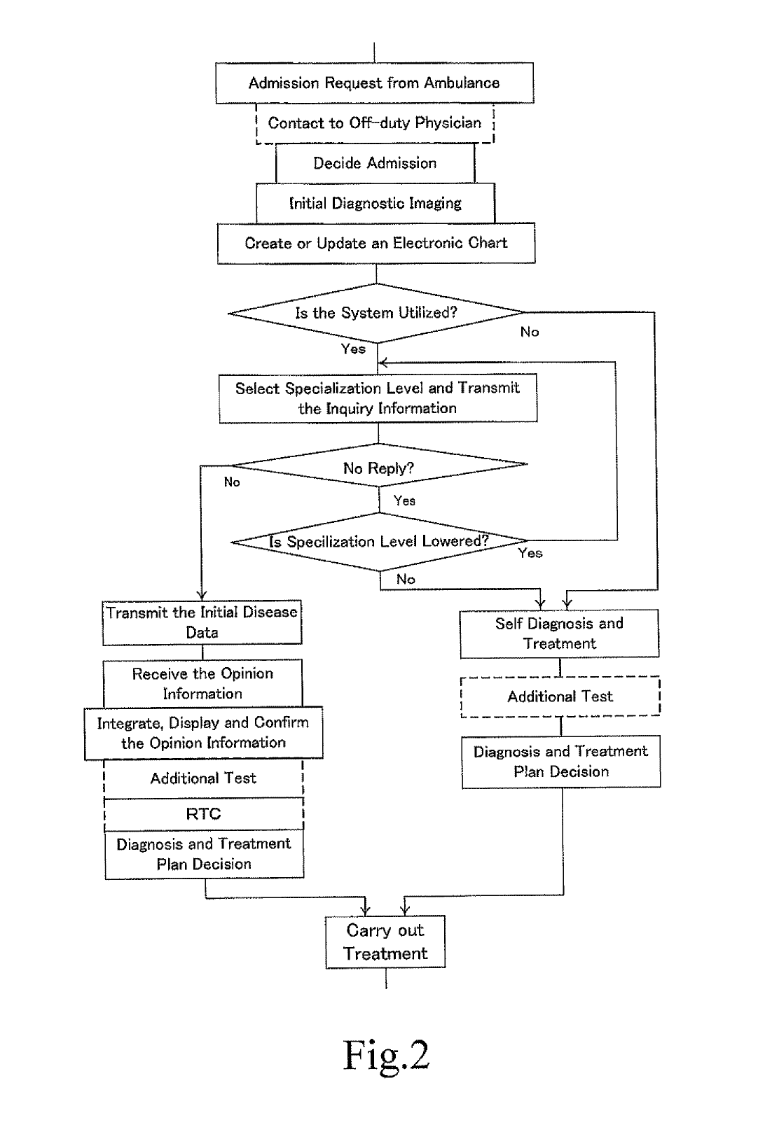

Before detailed description of each part in the support system of this embodiment, a work flow of an emergency patient care utilizing the support system will be roughly described as follows. FIG. 2 roughly shows the work flow of an emergency patient care utilizing the support system of this embodiment. As shown in FIG. 2, the work begins with receiving a contact that an emergency disease occurs at a patient from an ambulance system. This is an inquiry about whether the hospital would admit the patient or not. Somebody in the family of the patient may make the inquiry directly.

Receiving the inquiry, the hospital decides whether the patient is admitted or not, after checking up whether any physician is able to attend, treatment equipment such as ICU is vacant, and so on. In such circumstances, when a physician specialized in the medical field of the presumable disease is off duty, a contact is made to his/her cell phone, asking whether he/she is able to get to the work with the arrival of the patient. If able, the hospital makes a reply that the patient is admissible.

When the patient arrives, condition of the patient is evaluated, and any required emergency test and investigation are carried out immediately. That may be an imaging investigation, such as X-ray, MRI or CT. The image obtained is hereinafter called “initial disease image”. Some simple evaluation and tests such as body temperature and blood pressure may be carried out in the ambulance during the delivery.

After the initial tests and investigations or in parallel with it, a new electronic chart is created for the patient. If the patient has had any medical care in the hospital so far, the chart of the patient is updated, not creating new one, with adequate timing of the progress of diagnosis and treatment.

Then it is decided whether the support system is used or not in treating the emergency patient. It means to decide whether a diagnosis or treatment is carried out asking expert-physicians belonging to other medical facilities for opinions. It is considered first if the physician in charge can make decisions on the diagnosis (diagnostic details) and treatment (treatment plan) by him/herself, whether any additional investigation and test is necessary, and so on. This support system is used, if the decisions cannot be made by the physician in charge, or if opinions of the expert-physicians should be referred to anyway.

When the support system is not used, the physician in charge by him/herself establishes diagnosis and then treats the disease as any additional investigation and test is carried out if necessary. When utilization of the support system is decided, one of the primary terminals 1 sends inquiry information to inquire in advance of each appropriate expert-physician whether he/she will be available to provide an opinion, after deciding the specialization level of the expert-physicians to inquire of.

If no expert-physicians reply “available”, it is considered to lower the specialization level of them. If not lowered, utilization of the support system is abandoned, and the diagnostic work-up and treatment are carried out only by the physician in charge. If lowered, the specialization level is set again, and then the inquiry information is sent from the primary terminal 1 again.

If at least one expert-physician replies “available”, clinical data at this moment, which include an initial disease image and is hereinafter referred as “initial disease data”, is sent to the expert-physician(s), inquiring for an opinion. The opinion is concerning the diagnosis, how it should be treated (treatment plan), or whether any additional test and investigation are necessary. The opinion could include two or more points. The opinion is the information transmitted to the support system. In the following description, the word “opinion” is used in this meaning.

The initial disease data is sent to each secondary terminal 2. Displaying the initial disease data on each secondary terminal 2, each expert-physician considers it, and then transmits the opinion from each secondary terminal 2. The opinion is received at the primary terminal 1, and confirmed by the physician in charge. Depending on the situation, a real-time communication such as chatting conference is carried out among the expert-physicians having provided the opinion and the physician in charge. Based on those steps, the physician in charge carries out a treatment after finalizing the diagnosis, an additional test (if necessary), and a treatment plan decision.

Each part of the support system of this embodiment utilized in carrying out the above work flow will be described in detail as follows. First of all, the database server 4 will be described. The database server 4, on which a database managing program is installed, has a storage, e.g., hard-disk storage. Various database files are stored in the storage. One of the database files is the EP-DBF referred before. As other files, there are an in-hospital physician database file (hereinafter, “IHP-DBF”) in which information of physicians working in the hospital is registered, a temporary case DBF in which information is registered temporarily for managing the usage of the system, and a temporary receiver DBF in which information about the secondary terminals 2 is registered temporarily on each case for managing usage of the system as well.

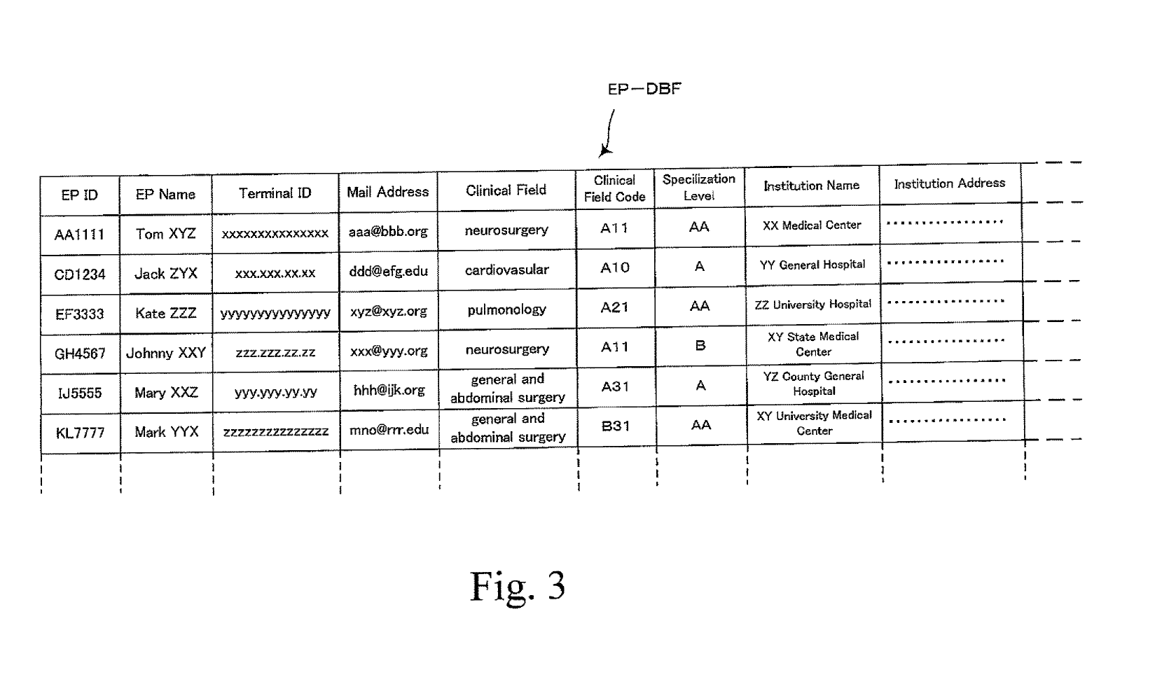

FIG. 3 roughly shows an example structure of EP-DBF. As shown in FIG. 3, many kinds of information about the expert-physicians are registered in the EP-DBF, e.g., “EP ID” which is an identification of the expert-physicians, “EP Name”, terminal addresses, and the like. The terminal addresses are the information to identify secondary terminals 2 as information receivers. In this embodiment, “Terminal Identification Information” and “Mail Address” are recorded as the terminal addresses. The terminal identification information is to identify each secondary terminal 2 handled by each expert-physician. This is IP address or MAC address if the terminal 2 is a desktop or notebook computer, or the like. It is MSI (mobile subscriber identity) or MEI (mobile equipment identity) if the terminal 2 is a cell phone, smart phone, PDA or the like. Although an E-mail address is used when information is transmitted by an E-mail, the terminal identification information may be used when information is transmitted by a server-side program such as FTP.

“Specialty Field” in the EP-DBF is the information about a clinical field in which a physician is expert. “Specialty Field Code” is the code information assigned to each specialty field for a search or other purposes. “Specialization level” is the information about how high the expertise level of the expert-physician is in the specialty field. In this embodiment, three ranks, “AA”, “A” and “B”, are given as the specialization levels. “AA” is highest, and “B” is lowest. For example, “B” may be the level of a sub-specialist physician, and “AA” may be the level of a teaching physician who is famous as authority in a clinical field, whereas “A” may be a middle level between them.

In addition, information about medical institutions to which the expert-physicians belong is registered in the EP-DBF. Although not shown, the fields “Profile” and “Number of Operated Cases” are provided in the EP-DBF as referential information to presume the specialization level, “Number of Operated Cases” is the information about how many times the expert-physician has carried out surgeries. Of course, it means how much experience the expert-physician has. Although not shown either, the field “Terminal Type” is given in the EP-DBF. This is where the kind of each secondary terminal 2 is registered, e.g., “3G cell phone”, “smart phone”, “personal computer” or the like. This information is used for selecting the compression level of an image data as described later.

The support system of this embodiment comprises a register registering the above described information about the expert-physicians. One of the primary terminals 1 is provided as an administration terminal which a secretary in the hospital handles. The above described information of the expert-physicians are input at the administration terminal and recorded in the EP-DBF for registry. Therefore, the register is composed of the administration terminal, the database server 4 and other components.

Advance agreements to record the information on the database server 4 are provided from the expert-physicians, who are receivers of the inquiry information described later. Each expert-physician sends the information via E-mail, facsimile or regular mail. The secretary handles the administration terminal to access the database server 4, inputs the information sent by each physician, and records it in the EP-DBF.

The terminal identification information or other information may be obtained by a secondary terminal 2 when it makes an access to the communication server 3 via the Internet, because of convenience. For example, an E-mail in which access information to the communication server 3 (e.g., URL) is written is sent to a secondary terminal 2, and then makes the secondary terminal 2 access to the communication server 3. The communication server 3 reads out the terminal identification information and E-mail address from the session information in the access, and sends them to the database server 4 to record thereon. Because this part of the system can be the same as in many web sites having membership registrations, detailed description is omitted.

The IHP-DBF will be described as follows. Although a figure is omitted, the IHP-DBF is the database file having the fields of “In-hospital Physician ID” given to each in-hospital physician, “In-hospital physician Name” and “Clinical Department”. A password has been issued to each in-hospital physician. Each password is also recorded in the IHP-DBF.

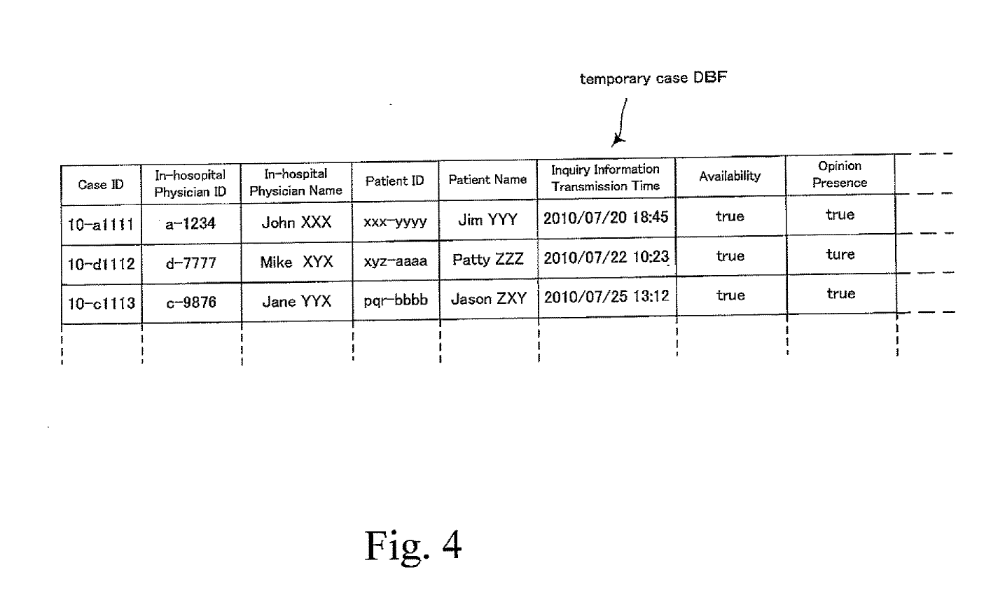

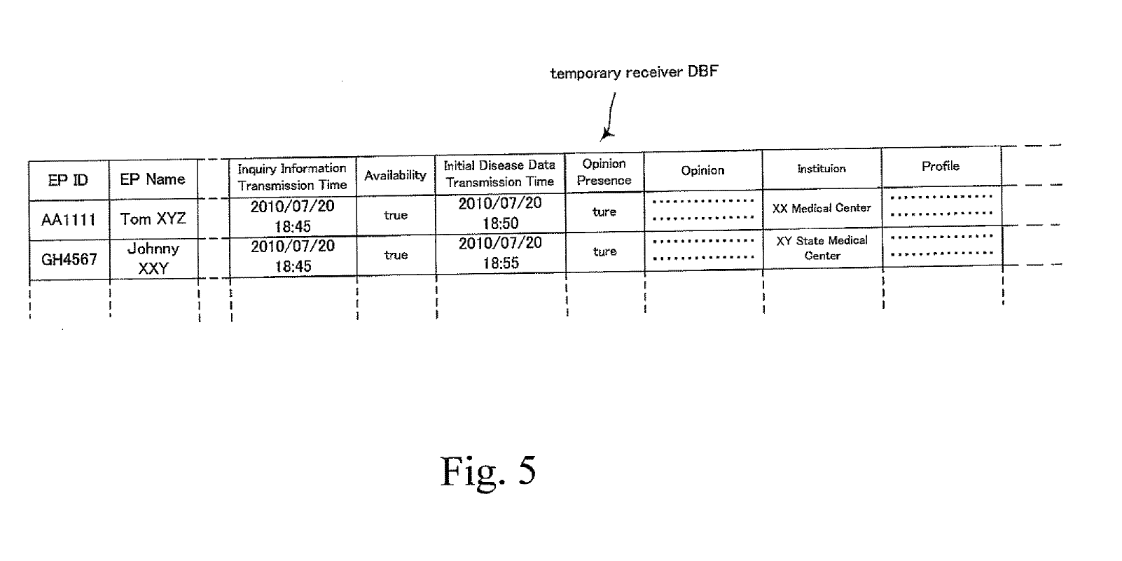

The temporary case DBF and temporary receiver DBF will be described in detail as follows. FIG. 4 roughly shows an example structure of the temporary case DBF. As shown in FIG. 4, the temporary case DBF has the fields of “Case ID”, “In-hospital physician ID”, “Inquiry Information Transmission Time” and “Availability”. FIG. 5 roughly shows an example structure of the temporary receiver DBF. The temporary receiver DBF is made for one emergency medical care (i.e., one case) utilizing this support system. In other words, the temporary receiver DBF is newly made in every time when use of the support system is started for a new emergency patient. The temporary receiver DBF is made under a filename using the case ID shown in FIG. 4. As shown in FIG. 5, the temporary receiver DBF has the fields of “Availability” and “Initial disease data Transmission Time” in addition to “Inquiry Information Transmission Time”.

The communication server 3 will be described next in detail. The communication server 3 is to implement a server-client environment in relation to the terminals 1, 2, thereby providing various services and information. One of these important services is being an agent in exchanging information among the terminals 1, 2. Because the information exchange is in many cases done by E-mail transmissions, a server-side program for E-mail transmissions (i.e., MTA) is installed on the communication server 3, for example, sendmail, qmail or the like. In addition, the communication server 3 is capable of providing web pages via HTML protocol and forwarding files via FTP. Because those are the same as in usual web servers, detailed description is omitted.

The support system of this embodiment comprises an initial transmitter to transmit the initial disease data. As components of the initial transmitter, the support System comprises the communication server 3 and an initial transmission program installed on the communication server 3. In addition to the initial transmission program, some special programs for services using the support system are installed on the communication server 3. These programs are related to each other and integrated. For convenience of description, “project” is introduced as the generic word for programs. The group of the integrated programs on the communication server 3 is hereinafter referred simply as “support project”.

Each program in the support project is written in an object-oriented programming language such as Java or VB (Microsoft Visual Basic). In the storage of the communication server 3, files for displaying form windows (hereinafter simply “forms”) on the terminals 1, 2 are memorized. The files for displaying forms are hereinafter referred simply as “form files” In each form file, a button to start a program in the support project (command button) may be embedded. In the forms displayed by the form file, the inquiry information and the initial disease data are input. A form file is sent to a terminal 1, 2 from the communication server 3 when requested, and then the form is displayed on the terminal 1, 2. Each program in the support project is installed at a predetermined URL (e.g., http://www.99medical.gr.jp/project/). Information transmissions among the terminals 1, 2 are carried out via this URL. When one of the terminals 1, 2 is accessing this URL, a variety of information is stored to session variables, thereby exchanging information among the terminals 1, 2 and among forms.

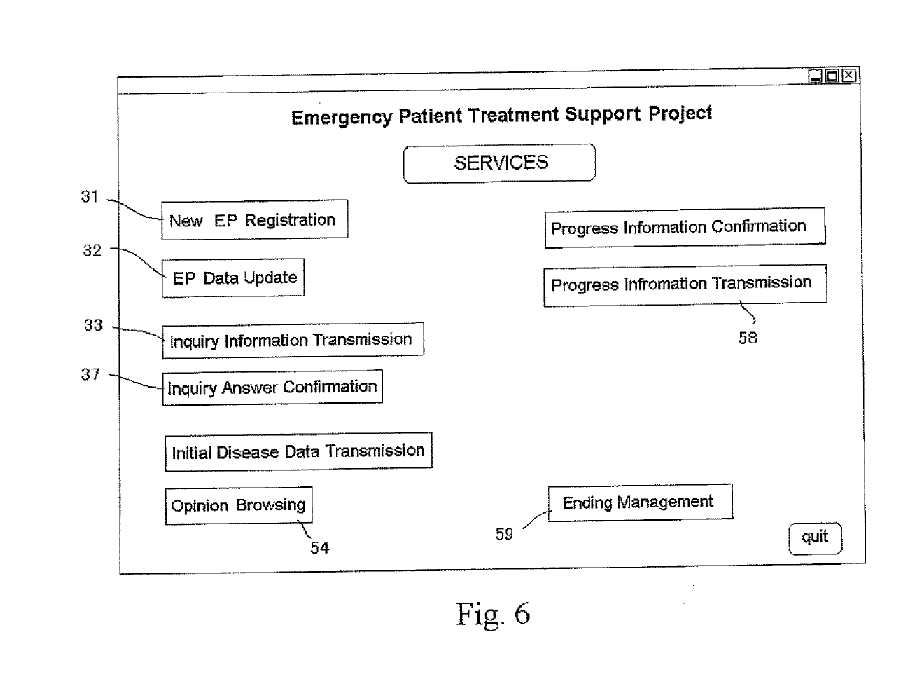

Many programs in the support project are to make each primary terminal 1 in the hospital carry out treatment support works. A menu form for executing those programs is provided. A form file of the menu form, hereinafter, “menu form file”, is stored in the storage of the communication server 3. FIG. 6 roughly shows an example of the menu form in the support project. The menu form file is read out from the storage, displaying the menu form, by clicking an icon provided on a regular operating screen depending on OS of a primary terminal 1, e.g., so-called desktop in Windows. In the example shown in FIG. 6, the primary terminal 1 is supposed to be a desktop computer. The menu form is also capable of being displayed on a mobile-type terminal used as the primary terminal 1. Another menu form file for mobile-type terminals is stored in the storage of the communication server 3.

As shown on FIG. 6, a command button 31 with the title “New EP Registration” is provided in the menu form. The command button 31 is to add a new record in the EP-DBF and newly register information about a new expert-physician. In the storage of the communication server 3, a form file for a form to input the information for each field in the EP-DBF shown in FIG. 4 is stored. This form file is read out and displays the form, hereinafter, “EP data entry form”, on a primary terminal 1 when the command button 31 is clicked. A register button is provided in the EP data entry form. When the register button is clicked after inputting the information of the new expert-physician, the database managing program is started, and then adds a new record in which the input information is recorded.

As shown on FIG. 6, a command button 32 with the title “EP Data Update” is provided in the menu form. In the storage of the communication server 3, a form file for a form to update the information of an expert-physician on the database server 3 is stored. This form is hereinafter referred as “EP update form”. When the command button 32 is clicked on a primary terminal 1, a window for inputting the name of an expert-physician or an expert-physician ID is displayed thereon. According to the information input in the window, the EP-DBF is searched, and then the information in the corresponding record is read out and filled in the EP update form, which is displayed on the primary terminal 1. The displayed information is updatable on the primary terminal 1. When the register button is clicked after changing the information in any field, the updated information is sent to the database server 4, and then overwritten in the corresponding record.

The support system of this embodiment comprises an inquiry information transmitter to transmit the inquiry information from a primary terminal 1. As components of the inquiry information transmitter, the support system comprises the communication server 3 and an inquiry information transmission program. More concretely, a command button 33 with the title “Inquiry Information Transmission”, hereinafter, “inquiry transmission button”, is provided in the menu form as shown in FIG. 6. In the storage of the communication server 3, form files of an inquiry information input form and inquiry information transmission form are stored. By clicking the inquiry transmission button 33 on a primary terminal 1, the inquiry information input form is displayed thereon.

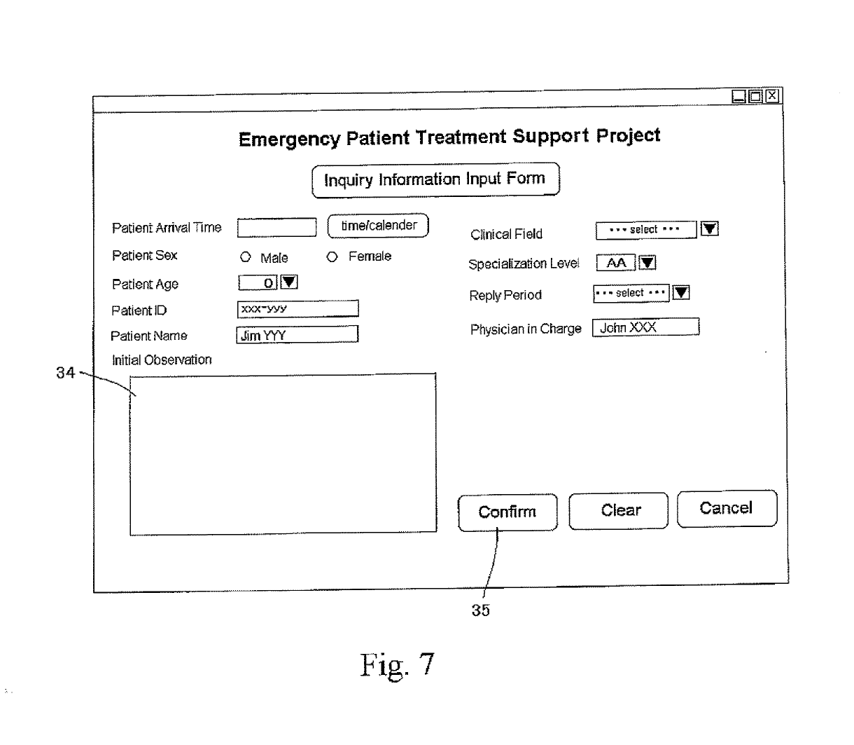

FIG. 7 roughly shows an example of the inquiry information input form. As shown in FIG. 7, the inquiry information input form comprises a patient arrival time input box, a patient sex input box, a patient age input box, a patient ID input box, an initial observation input box 34, a clinical field input box, a specialization level input box, and a reply period input box. In addition, a command button 35 with the title “Confirm”, hereinafter, “confirmation button”, is provided.

The patient arrival time input box is the box in which date and time when the emergency patient has arrived at the hospital are input. By clicking a command button with the title “time/calendar”, time and a calendar are shown by pulldown lists, so that the delivery time and date can be input easily by choosing items in the lists. The patient sex input box is a radio button, where either one is selected. The patient age input box comprises a pulldown list showing the numbers of age, where any number is selected.

The patient ID input box is filled in if the ID is known at this stage. If an emergency patient is brought to the hospital with his/her family or having a medical insurance card or a patient ID card issued by the hospital, the patient ID is input. If only the medical insurance card is held, the patient ID is acquired by searching the electronic chart server 7.

The initial observation input box 34 is a textbox, in which initial observation about the condition of the emergency patient is input in text. The initial observation is informed the expert-physicians in inquiring whether they can provide opinions on this case or not. For example, text information such as “he arrived complaining of a severe headache” or “xx is suspected” is entered. If the disease is neurological, some specific neurological observation and data (such as consciousness level or neurological condition of the patient) are often included.

The clinical field input box comprises a pulldown list of clinical fields. In this box, a clinical field selected from the list is input. This is the field where the expert-physicians, whom the physician in charge would like to ask to provide opinions, have specialties. The clinical field is determined or presumed from the patient's condition at the time of the initial observation.

The specialization level input box is where the expertise level of the expert-physician who is asked to provide the opinion is input. Because it is chosen from “AA”, “A” and “B” in this embodiment, the box comprises a pulldown list of those. If “AA” is chosen, it means that the physicians on the AA level are chosen. If “A” is chosen, it means that the physicians on the levels of A or higher, i.e., AA and A levels, are chosen. If “B” is chosen, it means that the physicians on the levels of B or higher, i.e., AA, A and B, are chosen.

The reply period input box is where the period to reply the opinion availability is input. For example, it is set as a time period from an inquiry information transmission, such as “within one hour”, “within three hours”, “within five hours” or “within seven hours”. Instead of this, the period may be set as the time and date as a limit, such as “by 19:00 today”, “by 21:00 today” or “by 23:00 today”.

The box with the title “Physician in Charge” is automatically filled in, according to the in-hospital physician ID input in a certification window which is displayed prior to the inquiry information input form. The in-hospital physician ID input in the certification is stored to a memory variable. In displaying the inquiry information input form, it is read out and used as a search key to search the IHP-DBF. By this, the name of the in-hospital physician is acquired and filled in the box of the form.

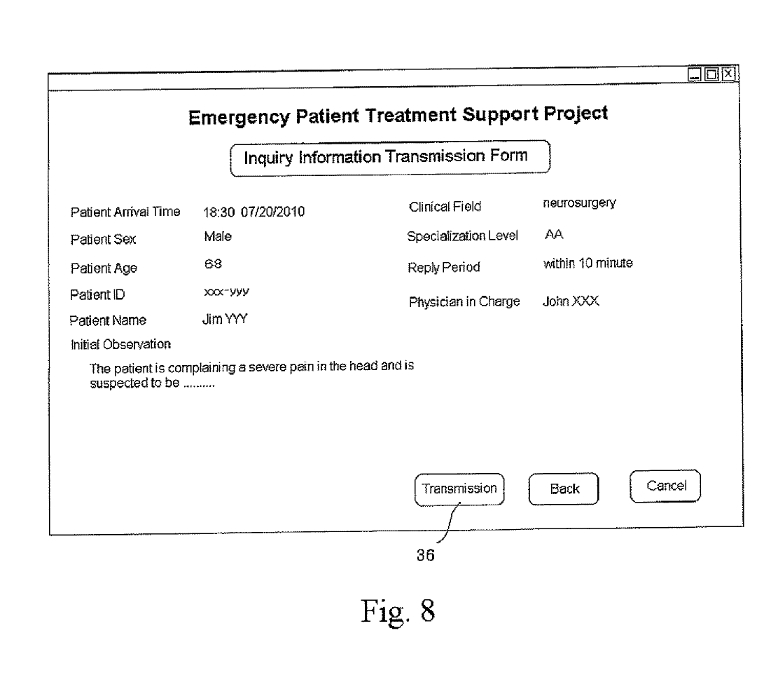

FIG. 8 roughly shows an example of the inquiry information transmission form. When the information is correctly input in each box in the form shown in FIG. 7 and then the confirmation button 35 is clicked, the inquiry information transmission form shown in FIG. 8 is displayed. In the inquiry information transmission form, the information input in the inquiry information input form is displayed for confirmation. By clicking a transmission button 36, the information is sent to the communication server 3. That is, a command to execute the inquiry transmission program is embedded in the transmission button 36. The transmission button 36 starts the program, passing the information input in the inquiry input form as arguments to the program. Nevertheless, exceptions exist in the information shown in FIG. 8. The patient ID and the patient name are not transmitted. This is because such information capable of identifying the patient should not be transmitted to any third party outside the hospital in view of privacy protection. The patient ID and the patient name are just confirmed on the primary terminal 1 by the physician in charge, not being sent out to the secondary terminals 2.

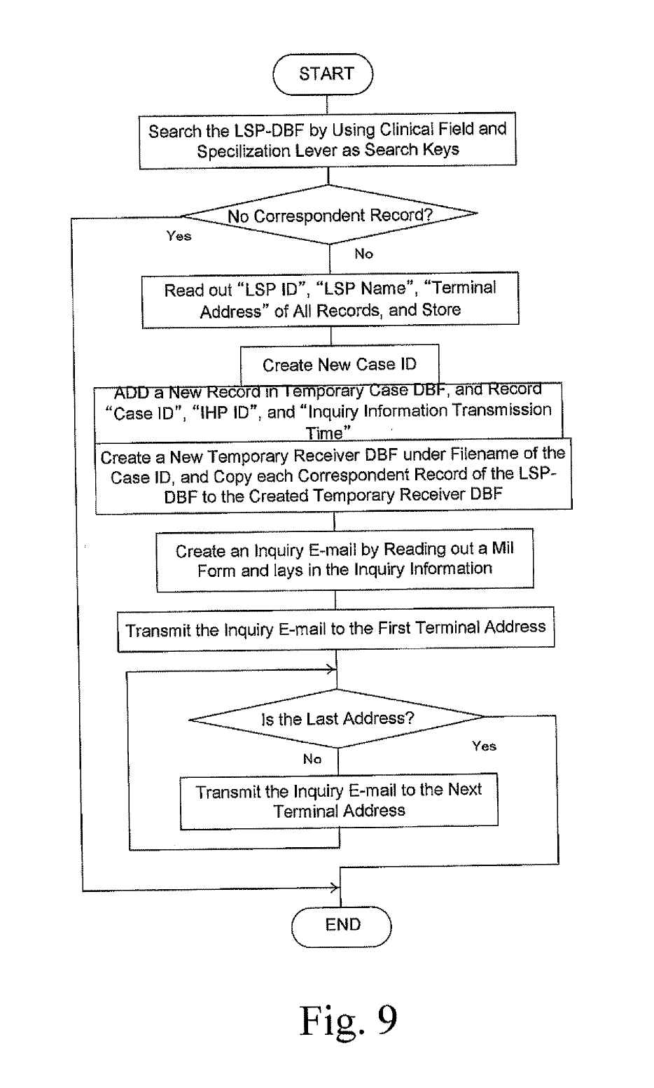

FIG. 9 is a schematic flowchart of the inquiry transmission program. As shown in FIG. 9, the program sends the information in the clinical field input box and the specialization level input box to the database server 4. Then the program searches the EP-DBF for any corresponding records, checking whether the input clinical field and specialization level correspond to the values in the fields of each record. If no corresponding record exists, the program is ended after displaying such a message as “no corresponding expert-physician is registered”. In this case, the inquiry information input form is displayed again.

If any corresponding record exists, the expert-physician ID, the expert-physician name and the terminal address are read out therefrom and memorized in memory variables temporarily. After finishing the search through all the records in the file, the program creates a new case ID and adds a new record in the temporary case DBF. The new case ID, the in-hospital physician ID and the inquiry information transmission time are recorded in the added new record in the temporary case DBF. Then the program creates a new temporary receiver DBF under the filename of the case ID. The information of the expert-physician ID, the expert-physician name and the terminal address, which have been read out from each corresponding record in the EP-DBF, is recorded in each new record of the new temporary receiver DBF. Afterward, the program reads out an E-mail form stored in the storage of the communication server 3, and lays the information input in the inquiry information input form. And then the program sends the E-mail to each terminal address in order.

The support system of this embodiment comprises a means for receiving and displaying the information transmitted from the communication server 3. As components of the means, the support system comprises each secondary terminal 2 and a receiving displaying program, hereinafter, “RD program”. Because information is sent via E-mail in this embodiment, the RD program is an E-mail program, i.e., mailer, installed in each secondary terminal 2.

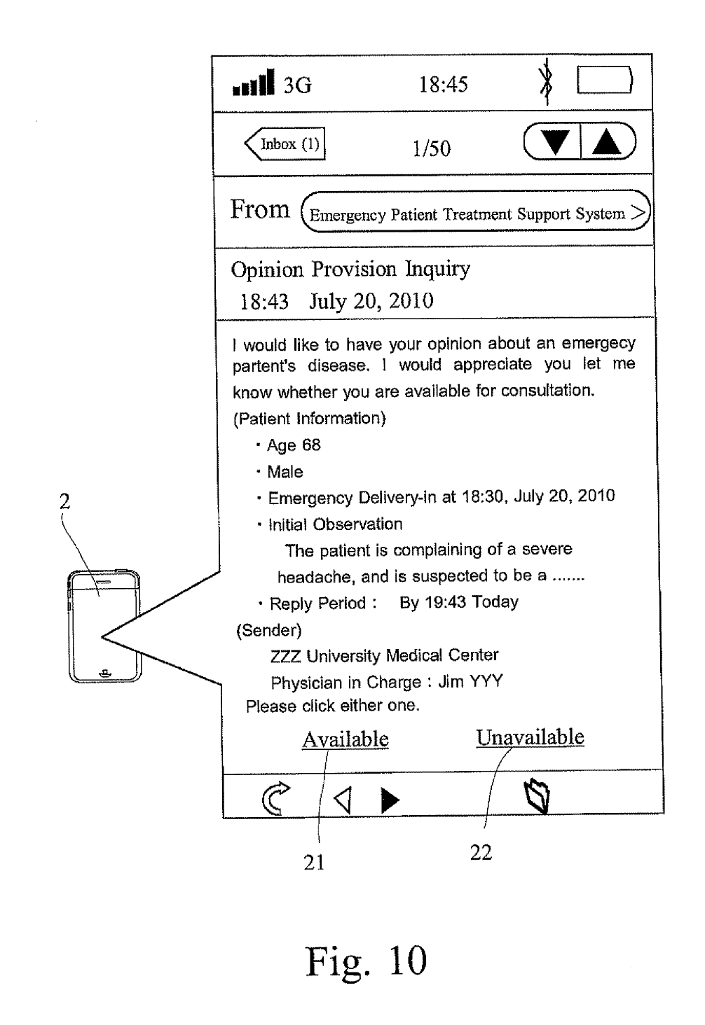

The E-mail in which the inquiry information is laid, hereinafter, “inquiry E-mail”, is transmitted to each secondary terminal 2 via the Internet as described. The inquiry E-mail is received and displayed at each secondary terminal 2 by the RD program. FIG. 10 roughly shows an example of the inquiry E-mail displayed on a secondary terminal 2. It shows a status where an inquiry E-mail is displayed on a secondary terminal 2 supposed to be a smart phone. However, the secondary terminal 2 could be another kind of mobile phone, a notebook or desktop computer.

As shown in FIG. 10, the inquiry information is displayed in the received inquiry E-mail on the secondary terminal 2. In this example, the reply period is set as within one hour from the inquiry information transmission. The inquiry transmission program has calculated the time one hour after and laid it in the E-mail. The name of the physician in charge and the department the physician in charge belongs to are displayed in the E-mail in this example, because the name of the communication server 3, “Emergency Patient Treatment Support System” here, is displayed as the sender in the inquiry E-mail by the mailer on the secondary terminal 2.

The support system of this embodiment comprises an availability information transmitter to transmit availability information from a secondary terminal 2 to a primary terminal 1. The availability information is regarding if an opinion can be provided or not. As components of the availability information transmitter, the support system comprises availability transmission buttons laid in the inquiry E-mail, the communication server 3, and an availability information transmission program.

As shown in FIG. 10, a command button 21 with the title “Available”, hereinafter, “available button”, and a command button 22 with the title “Unavailable”, hereinafter, “unavailable button”, are provided in the inquiry E-mail. Those are the availability transmission buttons.

The availability information transmission program is a server-side program. That is, the program is installed in the communication server 3 and executed by the availability information transmission buttons. The created case ID and a code meaning availability are embedded in each availability information transmission button. In the available button, more concretely, there is an embedded command to execute the availability information transmission program with the case ID, a code meaning “available” and a sender address (i.e., the address of a secondary terminal 2) as arguments. In the unavailable button, more concretely, there is an embedded command to execute the availability information transmission program with the case ID, a code meaning “unavailable” and the sender address as arguments.

The availability information transmission program opens the temporary receiver DBF where the case ID is the filename, and record the availability information (i.e., available or unavailable) in the field “Availability” of the corresponding record according to the terminal identification information acquired from the sender address or a session variable.

The availability information transmission program then transmits an E-mail to the primary terminal 1. This transmission is done only when the availability information is “available”, that is, only when the available button 21 is clicked, in order to immediately inform the physician in charge that the expert-physician replies “available”. Hereinafter, this E-mail is referred as “availability mail”.

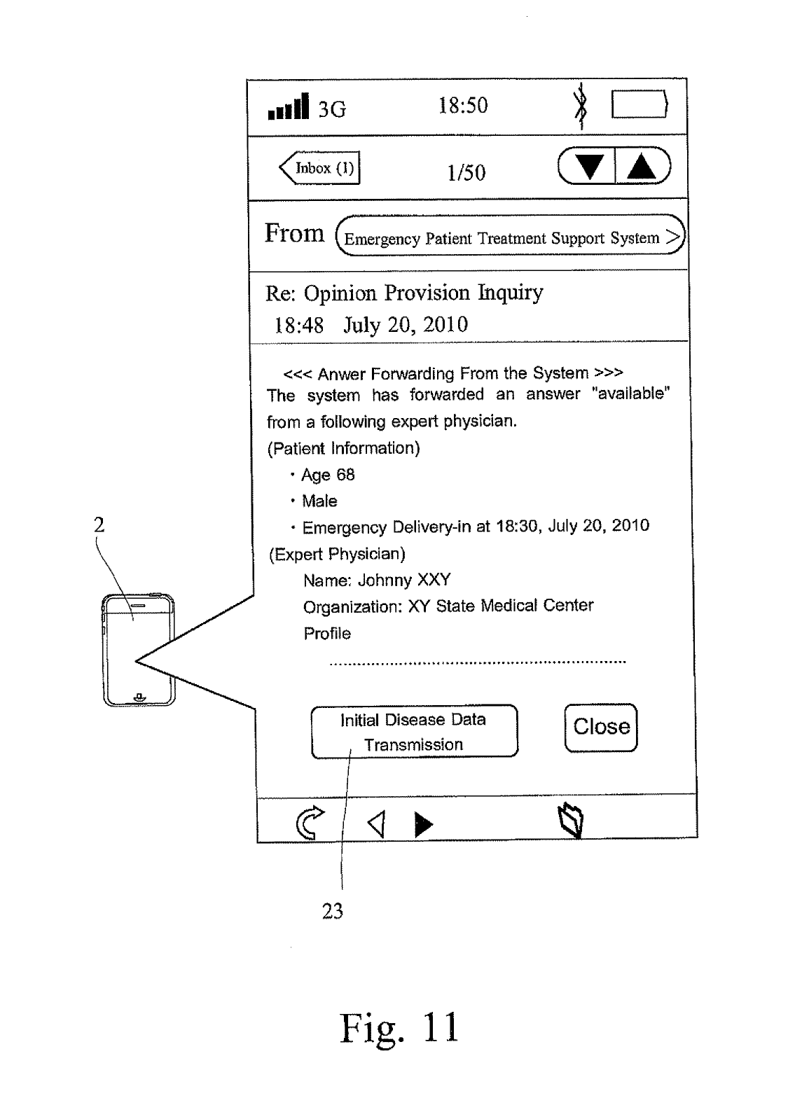

FIG. 11 roughly shows an example of the availability mail transmitted by the availability information transmission program. As shown in FIG. 11, the name and profile of the expert-physician replying “available” are included in the availability mail, as well as the inquiry information the physician in charge has sent is shown for confirmation. A template file for the availability mail is stored in the storage of the communication server 3. The availability information transmission program lays the above information in the template file, and then forwards it to the primary terminal 1.

The support system of this embodiment comprises a primary transmitter to transmit the initial disease data to formally request provision of an opinion. This request is transmitted only to each secondary terminal 2 handled by each expert-physician having replied “available”. The primary transmitter is a means to make the initial disease data input at a primary terminal 1, make the primary terminal 1 transmit the input data to the communication server 3, and forward it to each secondary terminal having replied “available”. The initial disease data includes a disease image of the patient and the time it was taken.

More concretely, as components of the primary transmitter, the support system comprises the primary terminal 1, the communication server 3 and a primary transmission program installed on the communication server 3. A form file for displaying a form to transmit the initial disease data, hereinafter, “initial disease data transmission form”, is stored in the storage of the communication server 3. As shown in FIG. 11, a command button 23 with the title “Initial Disease Data Transmission” is provided in the initial disease data transmission form. The command button 32 is to display the initial disease data transmission form on the primary terminal 1 by reading out the form file. A program is embedded in the command button 23. This program is to display the initial disease data transmission form, read out the sender terminal address from the session variable of the availability mail, and store it to a memory variable.

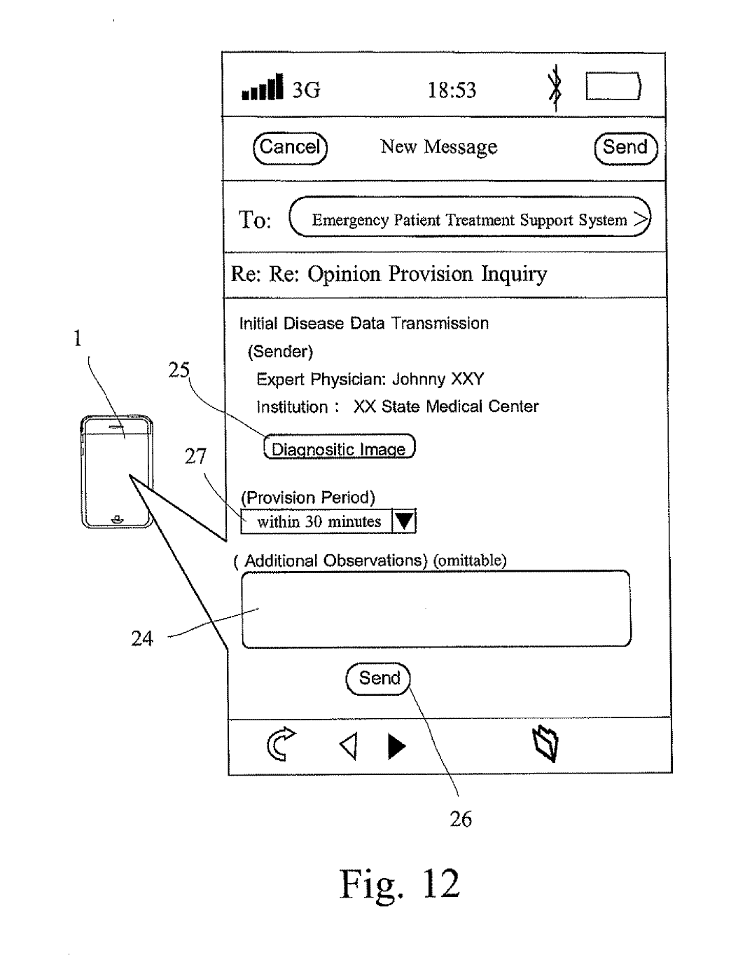

FIG. 12 roughly shows an example of the initial disease data transmission form. In this example, the primary terminal 1 is supposed to be a mobile-type terminal such as smart phone. The initial disease data transmission form includes an additional observation input box 24, an image confirmation button 25 and a transmission button 26, as well as displays the transmitted inquiry information for confirmation. In the additional observation input box 24, information about the subsequent condition of the emergency patient is input in text. It is an option, able to be omitted.

What is major in the initial disease data is an image. In the example shown in FIG. 12, an image data is automatically acquired and transmitted to a secondary terminal 2. The availability information transmission program embeds the case ID in the transmission button 26 in forwarding the availability mail. The transmission button 26 has therein an embedded program, which searches the temporary case DBF by using the case ID as search key, acquires information of “Patient Name” and “Patient ID” in the corresponding record, searches the PACS server 6 by using the patient ID as search key, acquires the file information of the image of the corresponding patient, and stores it in a memory variable.

Although the file information of the image is automatically acquired as described, it also can be confirmed in advance. The image confirmation button 25 shown in FIG. 12 is for this purpose. When the image confirmation button 25 is clicked, a new window is opened, and then the image is displayed therein by accessing the PACS server 6 according to the acquired file information. If there are multiple images for the patient, all file information of those is stored in the memory variable and transmitted. Otherwise, one of the images may be selected and transmitted.

As shown in FIG. 12, a provision period input box 27 is laid in the initial disease data transmission form. By what time the opinion shall be provided is input in this box 27. In this example, this box comprises a pulldown list to choose the time after transmitting the initial disease data, e.g., “within 30 minutes”, “within 1 hour”, “within 3 hours”, “within 5 hours” and the like.

The initial transmission program is executed by clicking the transmission button 26 shown in FIG. 12. A mail form for transmitting the initial disease data is stored in the storage of the communication server 3. The initial transmission program, which is installed in the communication server 3, reads out the mail form from the storage, reads out the image file information from the memory variable, lays the image file information in the mail form, and transmits it to the terminal address stored in the memory variable. This E-mail is hereinafter referred as “initial disease data mail”.

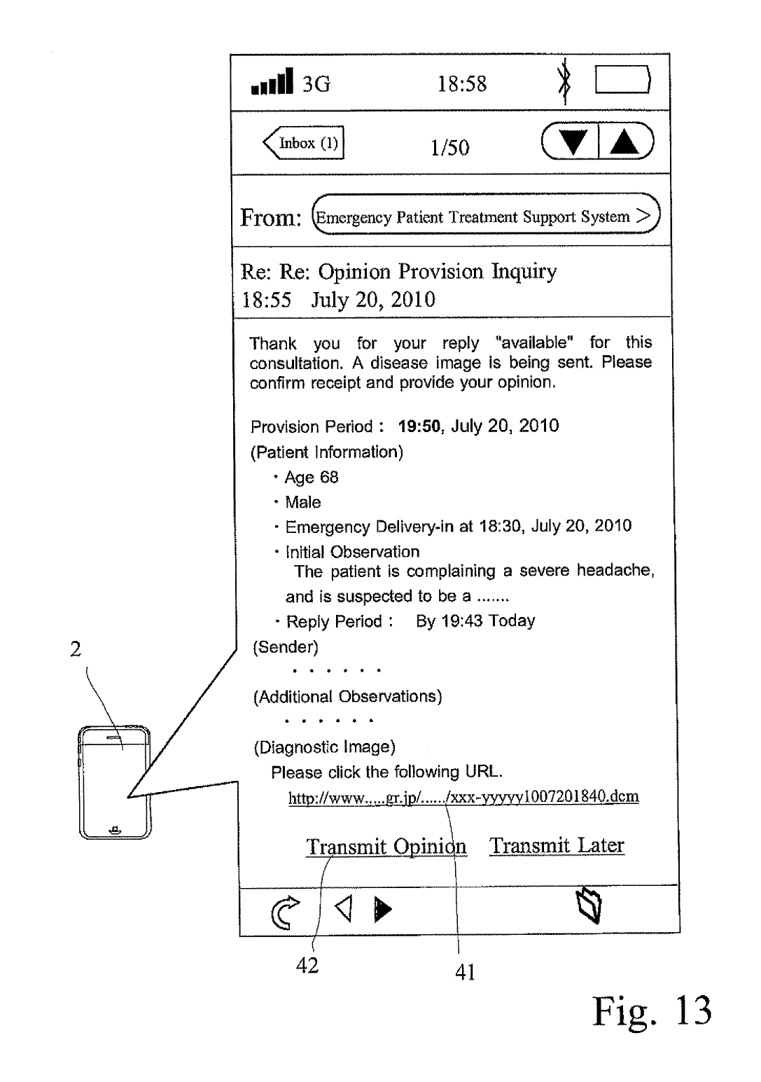

FIG. 13 roughly shows an example of the initial disease data mail received at a secondary terminal 2. As shown in FIG. 13, the initial disease data mail includes the patient information already sent in transmitting the inquiry information, the additional observations, and the opinion provision period. The initial transmission program searches the temporary case DBF by using the case ID as search key, acquires the patient information from the corresponding record, and lays them in the mail form.

In the example shown in FIG. 13, the image file is not attached to nor laid in the patient information mail, but is acquired by making an access. That is, an image browsing button 41 is provided in the initial disease data mail. An image displaying form is stored in the storage of the communication server 3, and an image displaying program is installed therein. The image browsing button 41 is to execute the image displaying program.

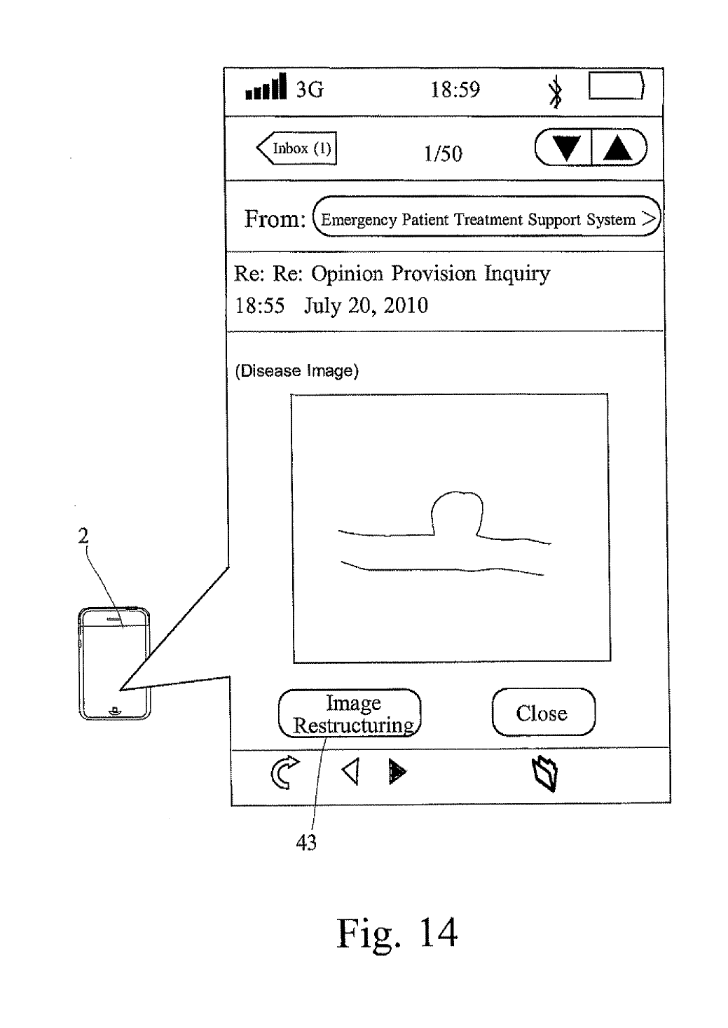

FIG. 14 roughly shows a status after clicking the image browsing button 41 in FIG. 13. The image browsing button 41 passes the case ID, the file information of the image, and the terminal address or terminal identification information of the secondary terminal 2 displaying the initial disease data mail, to the image displaying program as arguments. The image displaying program opens the temporary receiver DBF according to the case ID, searches it by using the terminal address or terminal identification information as search key, judges whether it is the secondary terminal 2 having sent an availability mail or not. If it is judged that the secondary terminal 2 has sent an availability mail, the image display program allows the secondary terminal 2 to browse the image and acquire the image file from the PACS server 6 according to the file information. Then the program lays the image file in the image displaying form and sends it to the secondary terminal 2.

In this, the image displaying program makes an access to the EP-DBF, and acquires the information in the filed “Terminal Type”. After determining the compression level according to the terminal type and compressing the image file at the determined level, the image file is sent to the secondary terminal 2. The image file may be sent without any compression if the secondary terminal 2 is a desktop computer or workstation. Because the compression level is adequately chosen according the type of the secondary terminal 2, the image can be displayed in an optimal condition according to the performance of the secondary terminal 2. After displaying the image on the secondary terminal 2 as shown in FIG. 14, the server-side control is transited to the PACS server 6. Therefore, the secondary terminal 2 is capable of accessing the PACS server 6 and executing programs thereon.

As shown on FIG. 14, a command button 43 with the title “Image Restructuring”, hereinafter, “image restructuring button”, is laid in the image displaying form. An image restructuring program is installed on the PACS server 6. The image restructuring program is to restructure an image and send it to a secondary terminal 2. As described, the images are taken with imaging equipment such as X-ray, CT and MRI devices. As known, this kind of imaging equipment is often digitalized, outputting digital image data. A variety of data processing is carried out in visualizing the image data. The image restructuring program is the component of a means to display a restructured image on a secondary terminal by carrying out a different data processing.

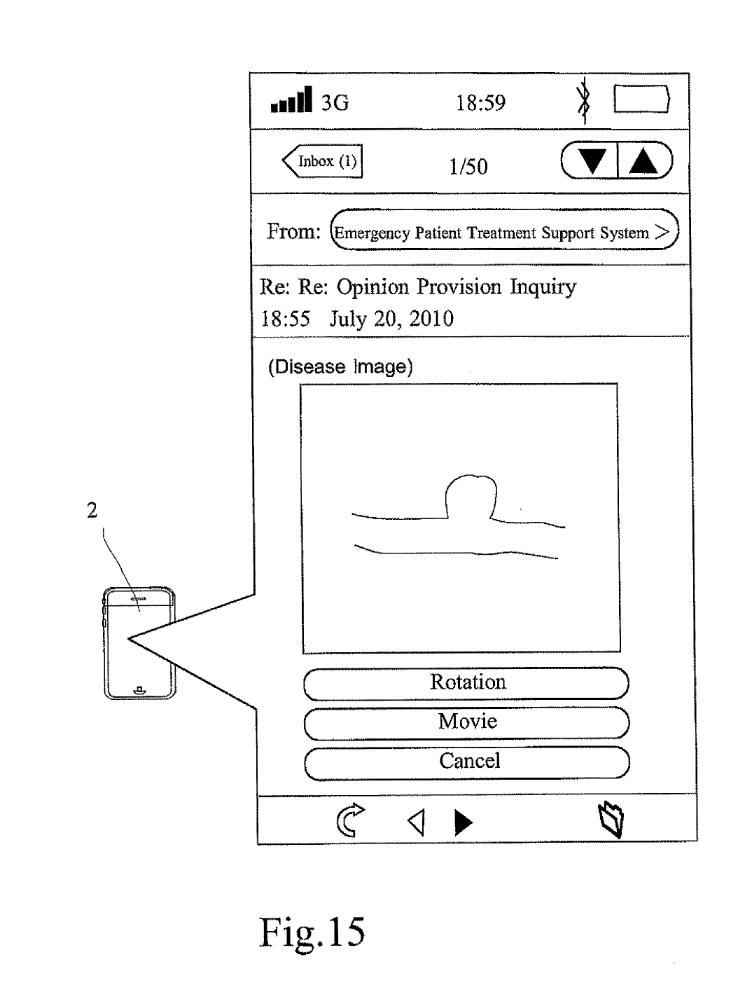

FIG. 15 roughly shows an example status of the secondary terminal 2 when the image restructuring button 43 is clicked. As shown on FIG. 15, a menu list of the image restructuring options is displayed first. In this example, two kinds of restructuring, “rotation” and “movie”, are possible. The “rotation” restructuring is to display another image taken at a different angle for a diseased part of a patient. The “movie” restructuring is to restructure an image data as movie and display it on a secondary terminal 2. For the movie restructuring, there are two different examples. One is that an image data is originally a movie data. The other one is to restructure data of multiple single images as a movie. In the former case, the initial image data are frame by frame captured form the original movie data. In restructuring, therefore, it is necessary to assign frames to be replayed from the movie data. In the latter case, a movie may be created by connecting many images taken in sequence, such as images of X-ray CT or MRI taken at predetermined angles.

Points featuring this embodiment in the image restructuring are that such a restructuring program can be executed by a secondary terminal 2 located outside the hospital, and that only an expert-physician having replied “available” is authorized to do such processing.

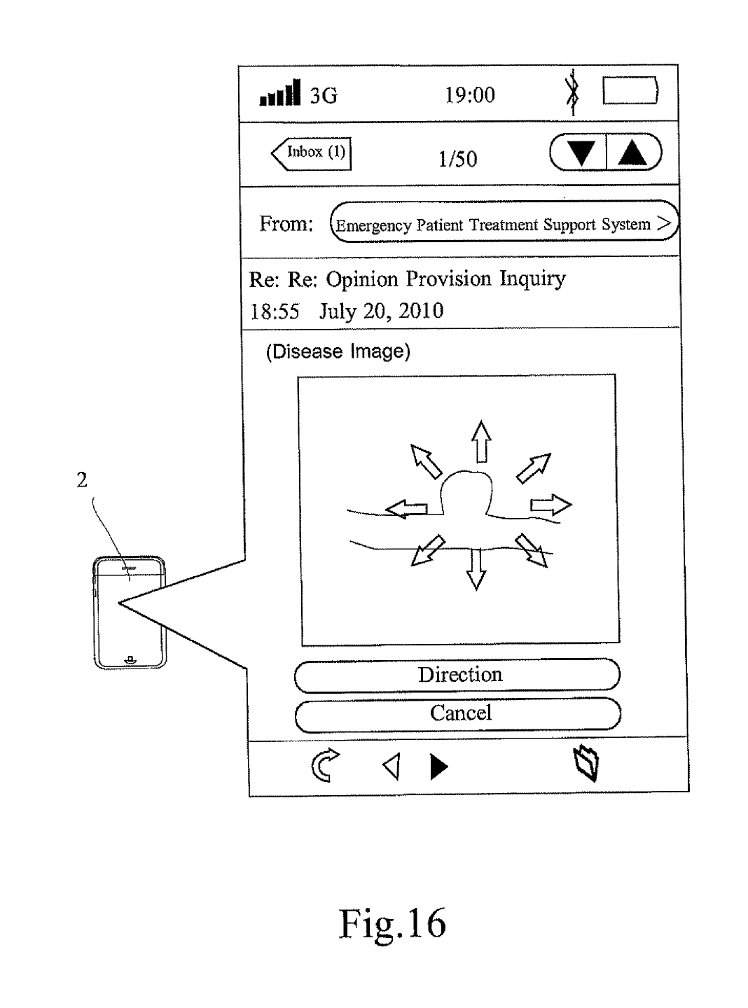

FIG. 16 schematically shows, for example, a status after the command button “rotation” on FIG. 15 is clicked. As shown on FIG. 16, arrows are superimposed on the images. The eight arrows are lengthened radiantly from the center of the image. Each arrow is a command button to execute a subprogram to direct the image in each arrow direction.

As shown in FIG. 16, a command button with the title “Direction” also appears by executing this image restructuring program. This button is to execute a subprogram to direct the image by a touch-and-drag on the display. As another example of restructuring, parts of the image may be extracted and displayed. For example, only bone parts or only veins may be extracted from an MRI image. Detailed descriptions on those image restructurings are omitted because those can be the same as in well-known PACS servers.

In another case, the initial image may be a movie. That is, a movie may be displayed by clicking the image browsing button 41. In this case, the movie is not only one taken in the past, but may be a real time picture. For example, the output data of a continuing investigation device, such as electrocardiographic device, may be sent by a streaming transmission. For this, a streaming transmission program is installed on the communication server 3, which is executed by clicking the image browsing button 41. The streaming transmission of a movie is particularly desirable, considering that it is used in treating an emergency disease. A treatment option for a seriously ill emergency patient must be decided urgently. In this, if an expert-physician watches a real time diagnostic movie, he/she can provide an opinion on site, the probability that a more adequate treatment is carried out without being too late would increase. A movie may be directly included in the initial disease data mail.

Transmission of an opinion will be described next, returning to FIG. 13. The support system of this embodiment comprises a secondary transmitter to transmit an opinion from each secondary terminal 2 to the primary terminal 1. As components of the secondary transmitter, the support system comprises each secondary terminal 2, the communication server 3 and a secondary transmission program installed in the communication server 3.

In the image displaying forms shown in FIGS. 14-18, a command button with the title “cancel” is provided. In this cancel button, there is an embedded program to close the image displaying form, return to the initial disease data mail, and make the server control transit back to the communication server 3.

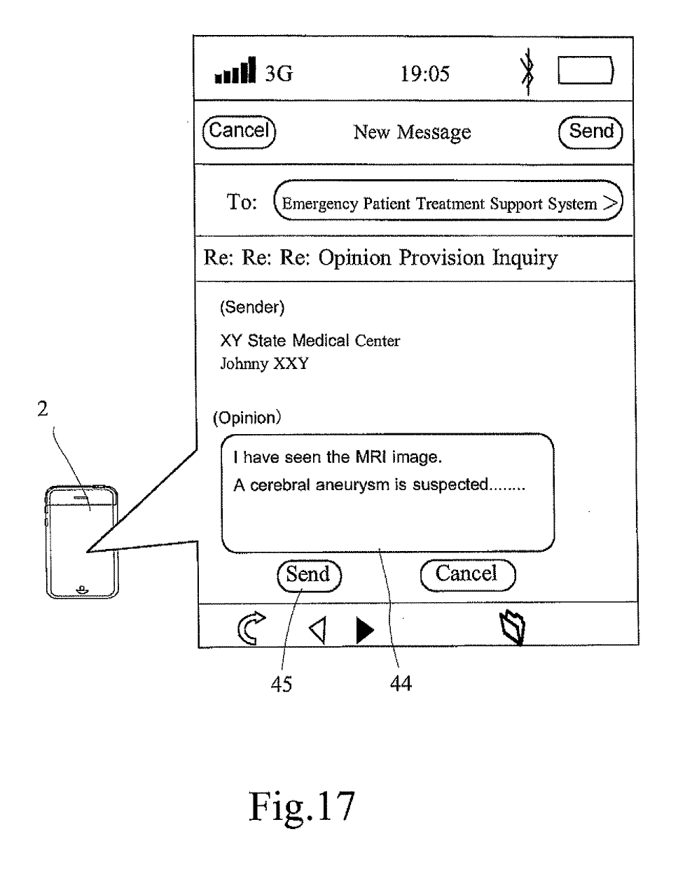

As shown on FIG. 13, a command button 42 with the title “opinion transmission”, hereinafter, “opinion transmission button”, is laid in the initial disease data mail. The form file for an opinion transmission form is stored in the storage of the communication server 3. A command to display the opinion transmission form is embedded in the opinion transmission button 42. FIG. 17 roughly shows an example of the opinion transmission form. As shown on FIG. 17, the opinion transmission form includes an opinion input box 44 where an opinion is input as text. The form also includes a transmission button 45. A command to execute the secondary transmission program is embedded in the transmission button 45. This command reads out the case ID and the expert-physician ID from the session variables, sends them to the communication server 3 with the input opinion, and then executes the secondary transmission program, passing the information to the program.

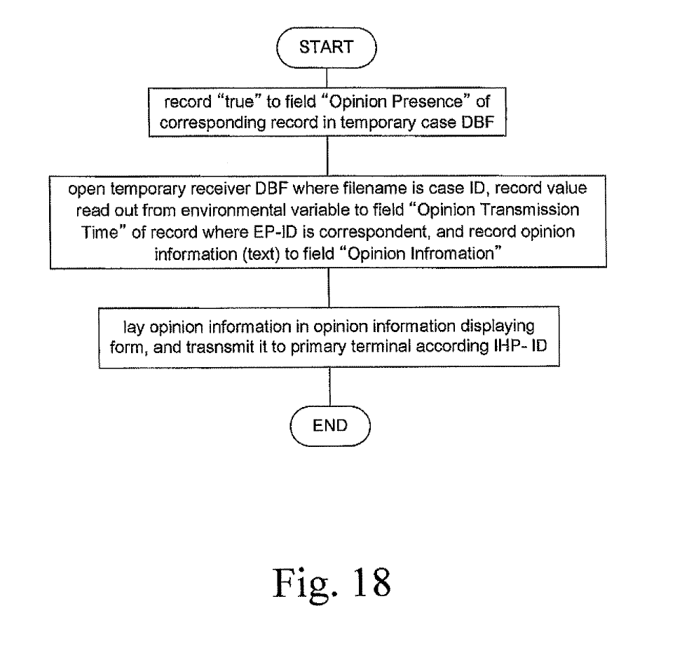

FIG. 18 roughly shows the flow chart of the secondary transmission program in this embodiment. The program opens the temporary case DBF, searches it by using the case ID as search key, and records the true value in the field “Opinion Presence” of the corresponding record. Then the program opens the temporary receiver DBF according to the case ID, searches it by using the expert-physician ID as search key, and records the time and date, which is acquired from an environmental variable, in the field “Opinion Transmission Time” of the corresponding record. The program also records the opinion (text) in the field “Opinion” of the corresponding record.

A form file for a form to display an opinion on a primary terminal 1 is stored in the storage of the communication server 3. In this embodiment, because the opinion is transmitted via E-mail, the form is a mail form. Hereinafter, this form is referred as “opinion displaying form”, and the mail is referred as “opinion mail”. After recording the information in each DBF as described, the secondary transmission program lays the opinion sent from the secondary terminal 2 in the opinion displaying form, and forwards it to the primary terminal 1 handled by the physician in charge, according to the in-hospital physician ID recorded in the temporary case DBF. The program is ended with this.

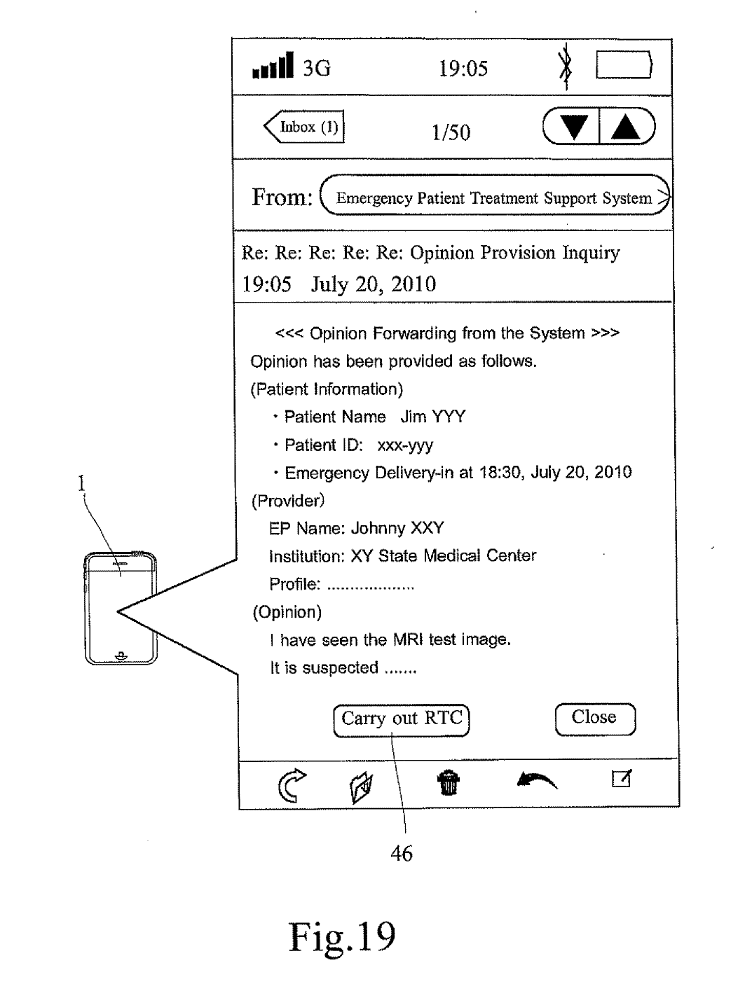

FIG. 19 roughly shows an example of the opinion mail displayed on a primary terminal 1. As shown on FIG. 19, the opinion mail includes the name of the expert-physician having sent the opinion, his/her profile as well as the opinion itself. The secondary transmission program reads out the expert-physician ID from the session variable, searches the EP-DBF, acquires the information of the name and profile of the expert-physician, and lays it in the opinion displaying form.

The opinion mail shown on FIG. 19 is a means to display and confirm the opinion immediately and individually on the primary terminal 1 when it is sent from the secondary terminal 2. In addition, the support system of this embodiment comprises a means to display integrally multiple opinions for one case (i.e., system utilization for one emergency patient) on a primary terminal 1. “Integrally” in this may mean displaying each opinion on the same terminal 1 so as to refer and compare to each other.

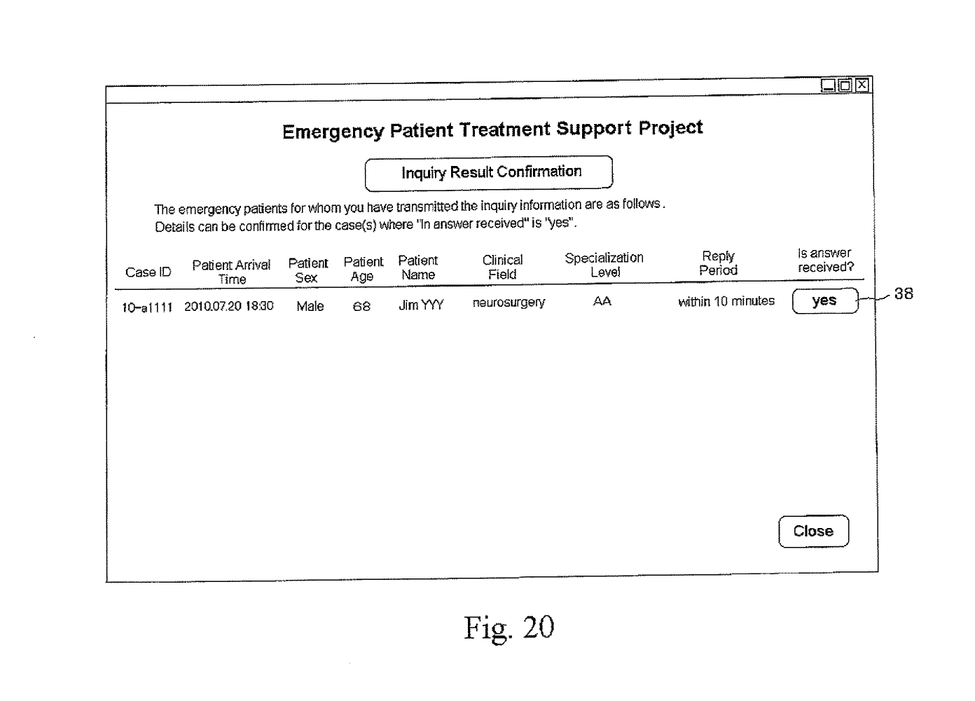

As shown on FIG. 6, more concretely, a command button 37 with the title “Inquiry Answer Confirmation”, hereinafter, “answer confirmation button”, is provided in the menu form. A form file for an inquiry result displaying form is stored in the storage of the communication server 3. FIG. 20 roughly shows an example of the inquiry result displaying form. A command to execute an answer confirmation program is embedded in the answer confirmation button 37 shown in FIG. 6. The answer confirmation program is to display the inquiry result displaying form on a primary terminal 1 after confirming the qualification of a primary terminal handler. In this embodiment, information browsing is allowed for limited persons, considering that answers to the inquiry information and the opinion should not be browsed freely by any person in the hospital. When the answer confirmation button 37 is clicked, the answer confirmation program displays a form to input the in-hospital physician ID and password. If the input in-hospital physician ID and password are judged correct by referring the information registered in the IHP-DBF, the program displays the inquiry result displaying form on the primary terminal 1 after storing the in-hospital physician ID to a memory variable. In this, the program searches the temporary case DBF by using the in-hospital physician ID as search key, reads out the information in each field in the record where the in-hospital physician ID is correspondent, and lays it in the inquiry result displaying form.

In the example shown on FIG. 20, the name of the physician in charge is “John XXX”, and the inquiry results of all cases where he has sent the inquiry information are displayed. In this example, he has sent the inquiry information for only one case where the emergency patient's name is “Jim YYY”. The result of only one inquiry is shown. If this in-hospital physician is in charge of multiple emergency patients simultaneously and has sent the inquiry information in each case, the inquiry result displaying form includes a multiline list in which each result is displayed.

A form file for an integrated answer displaying form is stored in the storage of the communication server 3. In the inquiry result displaying form shown in FIG. 20, a command button 38 titled “yes” is provided in the row with the title “Is Answer Received?” This command button 38 is automatically created by the answer confirmation program, when the value in the field “Availability” of the corresponding record in the temporary case DBF is true. This command button 38 is to display the integrated answer displaying form, hereinafter, “answer displaying button”.

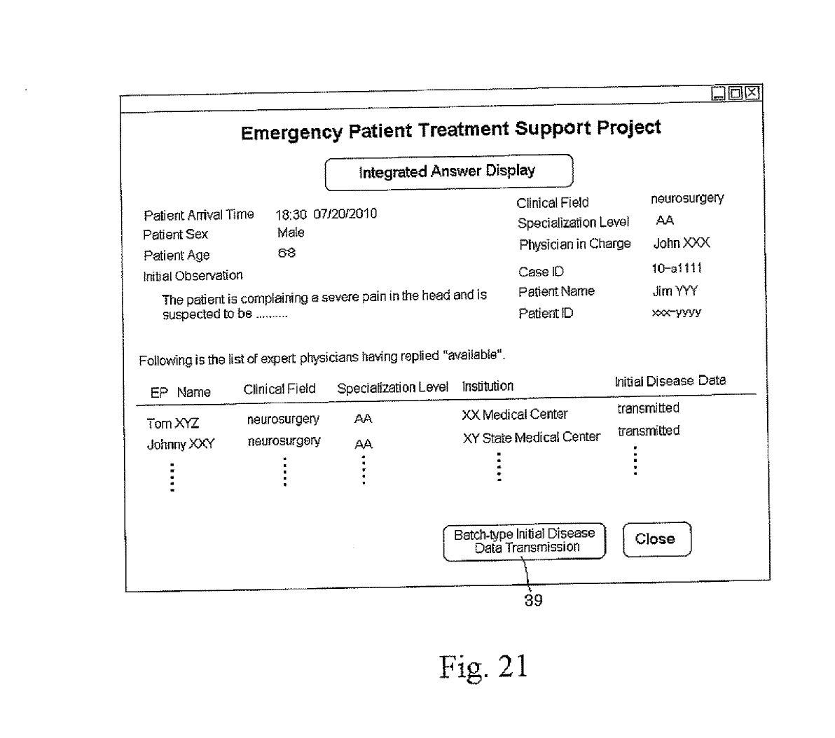

FIG. 21 roughly shows an example of the integrated answer displaying form displayed on the primary terminal 1. As shown on FIG. 21, the information of each expert-physician having replied “available” is displayed in the integrated answer displaying form, as well as the patient information for the case ID and the transmitted initial disease data. The command button 38 is to execute a program, which opens the temporary receiver DBF where the filename is of the case ID, acquires the expert-physician ID in the records where the value of the field “Availability” is true, acquires the information in the records where the expert-physician ID is correspondent to those in the EP-DBF, and displays the acquired information as a list in the integrated answer displaying form. The row titled “Initial disease data” is displayed according to the value in the field “Initial disease data Transmission Time”. That is, “not transmitted” is displayed if the value is null, and “transmitted” is displayed if the value is not null.

As shown on FIG. 21, a command button 39 with the title “initial disease data batch-transmission”, hereinafter, “batch-transmission button”, is provided in the integrated answer displaying form. A form file for an image capturing form is stored in the storage of the communication server 3. The batch-transmission button 39 is linked to the image capturing form.

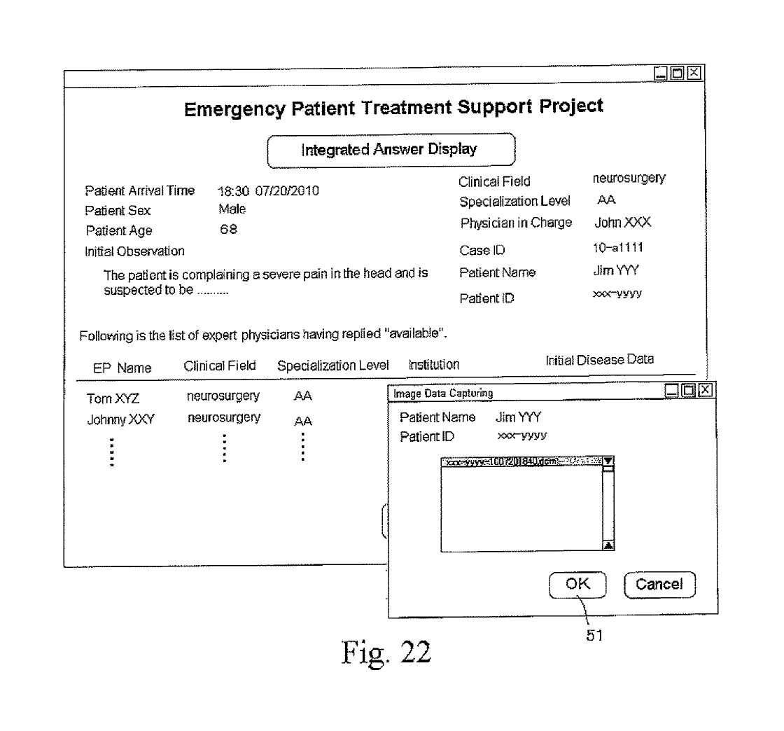

FIG. 22 roughly shows an example of the image capturing form. In this example, the image capturing form is overlaid on the integrated answer displaying form. As shown in FIG. 22, the image capturing form displays a window to choose an image file as well as the patient name and patient ID. The patient name and patient ID are acquired by searching the temporary case DBF by using the case ID as search key, which is read out from the session variable. In the batch-transmission button 39, there is an embedded program to access the PACS server 6, search it by using the patient ID as search key, acquire the image file information for the corresponding patient, and display it in the image capturing form as a list. As shown on FIG. 22, an OK button 51 is provided in the image capturing form. In the OK button 51, there is an embedded program to store the information of the chosen image file (path name and filename) to memory variables temporarily, and lay the filename in the initial disease data transmission form.

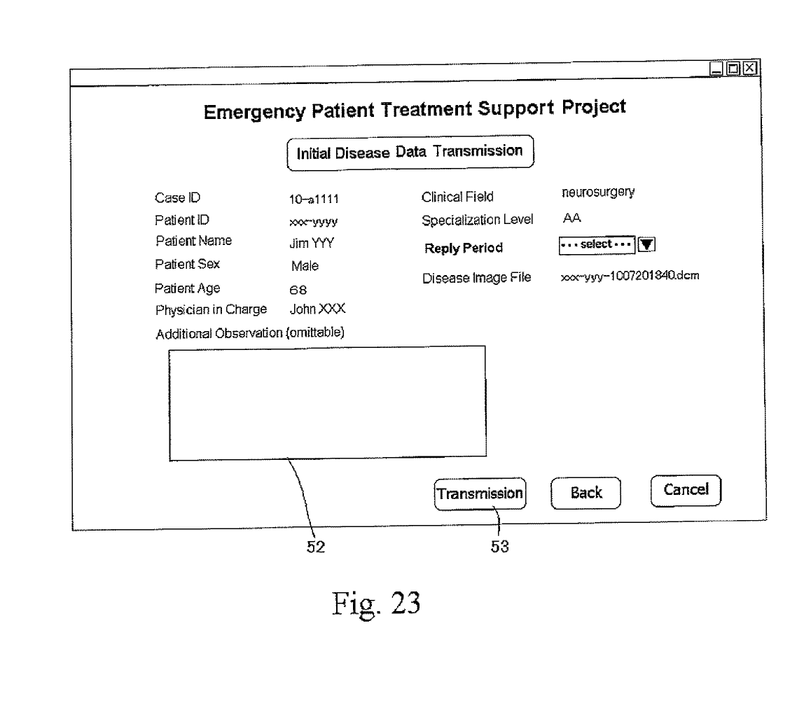

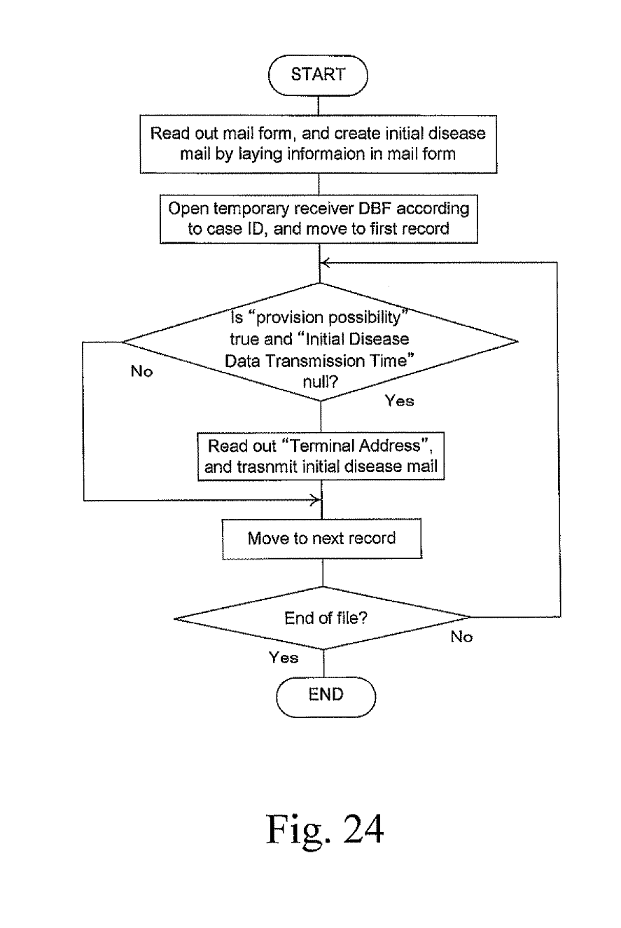

FIG. 23 roughly shows an example of the initial disease data transmission form in which the image file information is captured. In this example, the image file of the name “xxx-yyy-10007201840.dcm” is captured. As shown in FIG. 23, an opinion provision period input box 52, which comprises a pulldown list, is provided in the initial disease data transmission form. In a transmission button 53 shown in FIG. 23, there is an embedded command to execute a batch-type initial transmission program. FIG. 24 roughly shows a flow chart of the batch-type initial transmission program.

The batch-type initial transmission program lays the initial disease data input in the initial disease data transmission form, and transmits it to the terminal addresses in order via E-mails. Those terminal addresses are of the secondary terminals 2 which have replied “available” for the case ID, and to which no initial disease data has been transmitted (i.e., the terminal addresses for which the field “Initial disease data Transmission Time” is null). By transmitting the E-mails to all the corresponding terminal addresses, the batch-type initial transmission program is ended.

In the batch-type initial disease data transmission as described, it may be possible to automatically capture the image file information as same as in the form for the immediate-type initial disease data transmission shown on FIG. 12. Conversely, the image file information may be captured manually in the immediate-type transmission shown on FIG. 12. If there are multiple image files in the manual operation, one or more files may be selectively transmitted.

Integral display of opinions will be described next. As shown on FIG. 6, a command button 54 with the title “Opinion Browsing”, hereinafter, “opinion presence checking button”, is provided in the menu form. A form file for an opinion presence displaying form is stored in the storage of the communication server 3. In the opinion presence checking button 54, there is an embedded command to execute a program to display the opinion presence displaying form on a primary terminal 1. The opinion presence displaying program first checks the access right by making the in-hospital physician ID and password input, as same as in the inquiry result displaying program. Then the program searches the IHP-DBF by using the in-hospital physician ID as search key, reads out the information of each field in the corresponding record, lays it in the opinion presence displaying form, and then transmits it to the primary terminal 1.

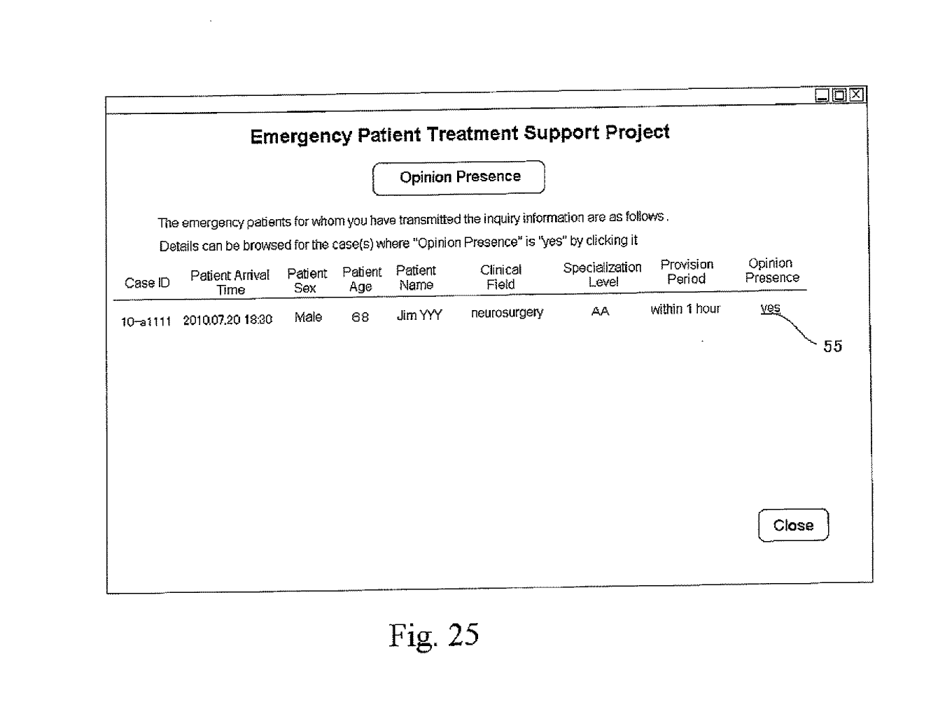

FIG. 25 roughly shows an example of the opinion presence displaying form. As shown in FIG. 25, information in case(s) where the in-hospital physician has transmitted the inquiry information is displayed in a list. In this example, because this in-hospital physician is in charge of only one case, only one line is displayed in the list. Last in the list, there is a row with the title “Opinion Presence”. In this row, a command button 55 with the title “yes” is provided. The command button 55, hereinafter, “opinion browsing button”, is automatically created by the opinion presence displaying program, only when the value of the field “Opinion Presence” in the corresponding record of the temporary case DBF is true. In the command browsing button 55, there is an embedded command to execute an integrated opinion displaying program. A form file of an integrated opinion displaying form is stored in the storage of the communication server 3.

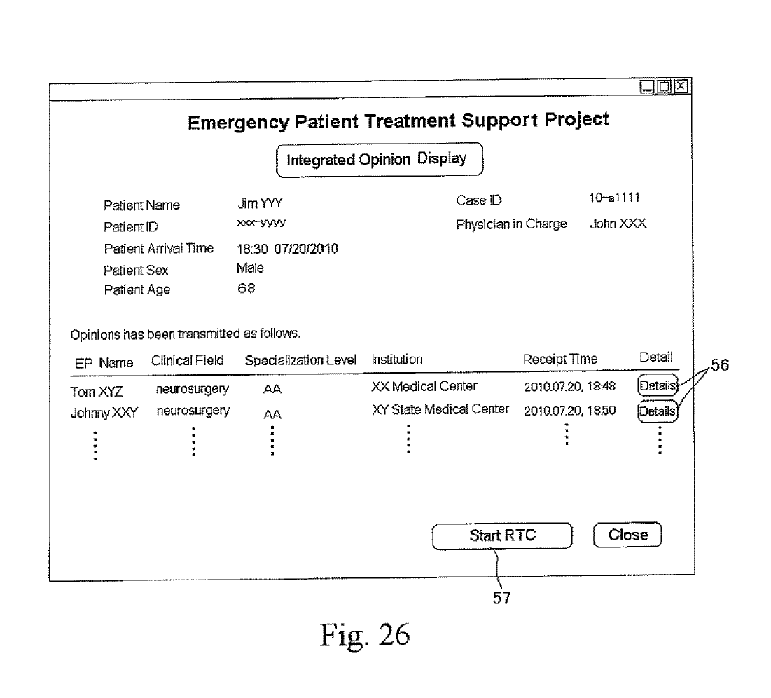

FIG. 26 roughly shows an example of the integrated opinion displaying form. The case ID is embedded in the opinion browsing button 55 shown on FIG. 25. The case ID is passed as argument to the integrated opinion displaying program. The integrated opinion displaying program opens the temporary receiver DBF according to the case ID, reads out the information recorded in each field, and lays it in the integrated opinion displaying form. In this, as for the records where the field “Opinion” is not null, the value in the field “Opinion”, which is the text information, is temporarily stored in a memory variable, and then a command button 56 with the title “Details”, hereinafter, “details button”, is automatically created in the integrated opinion displaying form as shown in FIG. 26.

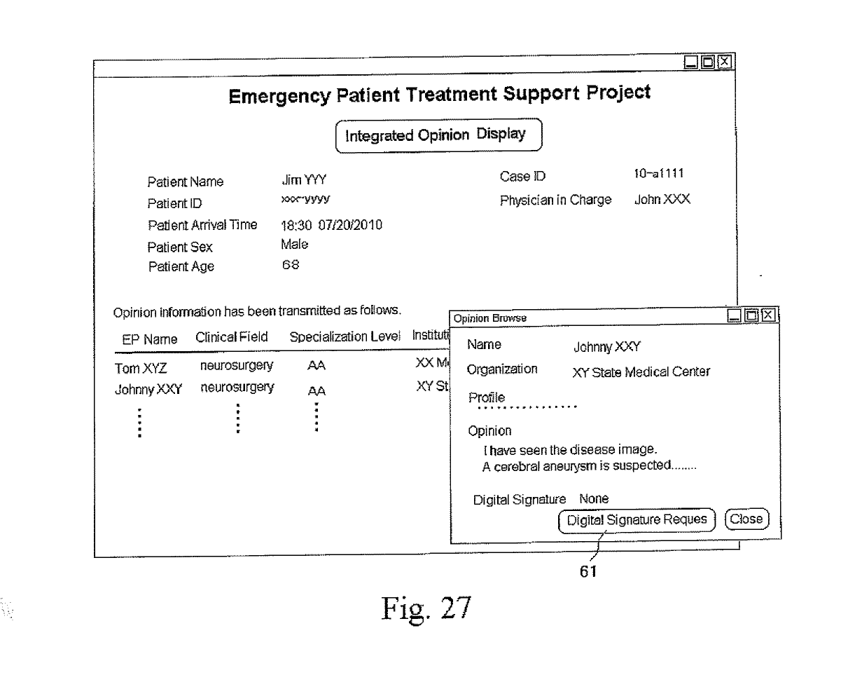

FIG. 27 roughly shows an example status when the details button 56 is clicked in FIG. 26. In the details button 56, there is an embedded program to read out the opinion from the memory variable and display it in another form. By clicking the details button 56, the opinion can be browsed as shown in FIG. 27.

As understood from FIG. 26 and FIG. 27, the information of the expert-physicians having provided the opinions is displayed as a list. By clicking the details button 56 in one of the lines in the list, the opinion the expert-physician in the line has provided can be browsed as well as his/her profile. Therefore, it is possible to browse each of the opinions provided by each expert-physician, and compare it to each other, considering what opinion is provided according to physician's profile.

A real-time communicator will be described next. The real-time communicator is what the support system of this embodiment comprises to carry out a real-time communication after the initial disease data is transmitted, making a group of the terminals 1, 2. The group is made of the primary terminal 1 having sent the inquiry information for a case, and all of the secondary terminals 2 having replied “available” to the inquiry information. The support system can choose to carry out the real-time communication by the real-time communicator when any one of the secondary terminal 2 transmits an opinion after the initial disease data are transmitted.

As shown on FIG. 19, a command button 46 with the title “Carry out RTC”, hereinafter, “RTC button”, is provided in the opinion mail. An initial RTC program is installed in the communication server 3. A command to execute the initial RTC program is embedded in the RTC button 46. A command button 57 of the same function is provided in the integrated opinion displaying form shown in FIG. 26.

The initial RTC program first creates a temporary database file for managing the real-time communication, hereinafter, “RTC-DBF”. The name of the RTC-DBF is given in a predetermined way using the case ID, for example, “10-a1111-rtc.dbf”. The initial RTC program next reads out the case ID from the session variable, and opens the temporary receiver DBF. Then the program reads out the information of the fields “EP ID”, “EP name”, “Terminal Address” and “Terminal Identification Information” in all the records in the temporary receiver DBF where the field “Availability” is the true value, and records it in each new record added in the RTC-DBF, i.e., copies the records. After copying all the records, the program adds another new record in the RTC-DBF, and records the information of the primary terminal 1 (i.e., terminal address or terminal identification information) therein. As a result, the terminal group is made of all the secondary terminals 2 having replied “available” for the case and the primary terminal 1 handled by the physician in charge for the case.

Afterward, the initial RTC program reads out a RTC mail form stored in the storage of the communication server 3, pastes the opinion (text) in the RTC mail form, and automatically forwards it to all the terminals 1, 2 of the group via E-mails. The RTC button 57 shown on FIG. 26 is clicked after designating any one of the opinions (i.e., any one of the lines), and then the RCT program is executed, resulting in that the real-time communication starts as the designated opinion is transmitted to all other secondary terminals 2 of the group.

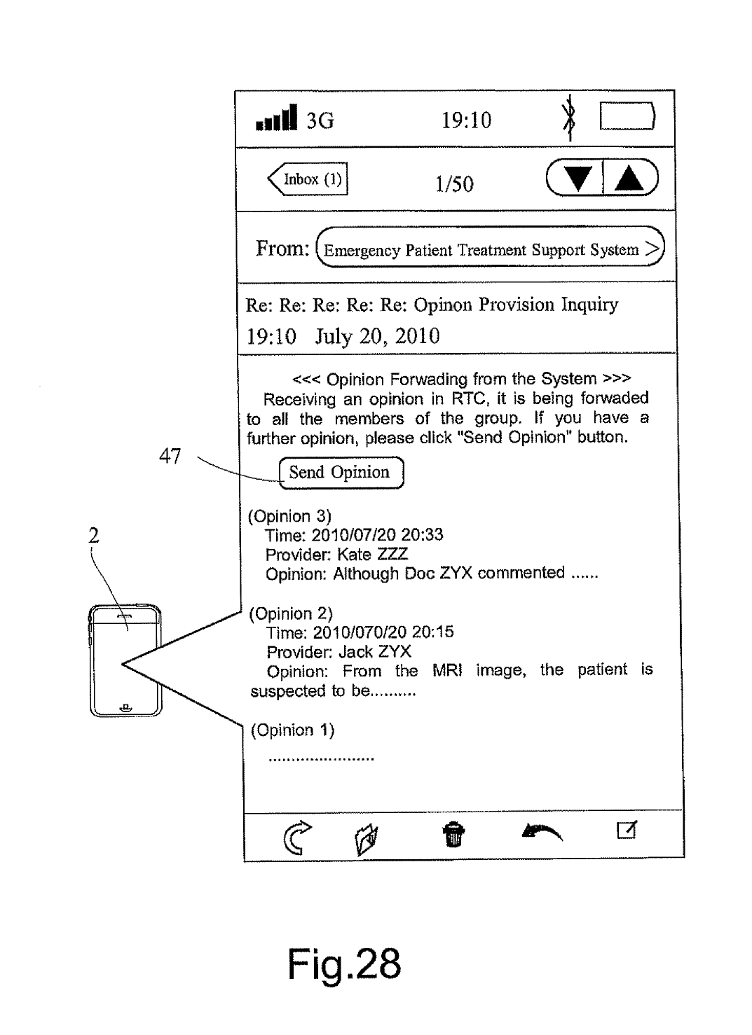

FIG. 28 roughly shows an example of the opinion mail automatically forwarded by the real-time communicator. This forwarded mail is hereinafter referred as “RTC forwarded mail”. As shown on FIG. 28, messages that the mail was automatically forwarded to all members of the group by the system, and that an opinion shall be input and sent if anyone has it, are laid in the RTC forwarded mail. In this embodiment, a further opinion is added to previous opinions and distributed. This example is in a situation where a third opinion has been added.

As shown on FIG. 28, a command button 47 with the title “Send an Opinion”, hereinafter, “opinion button”, is provided in the RTC forwarded mail. The opinion button 47 is linked to an opinion sending form having a reply message input box and transmission button. In the transmission button, there is an embedded command to execute a RTC automatic forwarding program installed on the communication server 3. The RTC automatic forwarding program creates an E-mail body by adding an input opinion to opinions previously sent, and lays it in the RTC mail form. The program sends the created E-mail automatically to all the terminals 1, 2 of the group except the sender secondary terminal 2. The automatic forwarded mail is received on the terminal for the physician in charge (primary terminal 1). Therefore, the physician in charge him/herself may reply. In this case, the automatic forwarded mail is distributed to all the secondary terminals 2 of the group.

A progress information transmitter will be described next. The support system of this embodiment comprises the progress information transmitter to transmit progress information to each secondary terminal 2. “Progress information” means information on condition of a patient, additional test and investigation, diagnosis, or treatment after transmitting an initial disease data. As components of the progress information transmitter, the support system comprises the primary terminal 1, the communication server 3 and some programs installed in the communication server 3. One of the programs is the first progress information transmission program to make the progress information input, process the progress information displaying form, and distribute an alarm mail to each secondary terminal 2. Another one of the programs is the second progress information transmitting program to transmit the processed progress information displaying form, responding to an access from each secondary terminal 2.

Even after receiving the opinion transmitted, responding to the initial disease data, the patient's condition could change by the minutes and hours. An additional test and medication are often carried out if necessary. Therefore, the information about such subsequent progresses should be transmitted to the expert-physicians. The progress information transmitter is in consideration of this point.

Similar to the transmission of additional observations in transmitting the initial disease data, the progress information may be input at the primary terminal 1, and transmitted to each secondary terminal 2 via the communication server 3. Nevertheless, the support system of this embodiment comprises a special component, considering the object of this system, i.e., supporting an emergency patient treatment. That is, the support system comprises a component to include time information in the progress information, and transmits the progress information so that it is displayed with a time bar. The time bar is a line showing a time scale.

In the menu form shown on FIG. 6, a command button 58 with the title “Progress information Transmission”, hereinafter, “progress information transmission button”, is provided. A form file for an information category selecting form is stored in the storage of the communication server 3. By clicking the progress information transmission button 58 on a primary terminal 1, the information category selecting form is displayed thereon. At least three command buttons are provided in the information category selecting form. The first is the command button to select an image (i.e., output of imaging equipment) as the progress information, hereinafter, “image selecting button”. The second is the command button to select a numerical data such as blood pressure, heart rate and body temperature as the progress information, hereinafter, “numerical data selecting button”. The third is the command button to select medication information as the progress information, hereinafter, “medication selecting button”.

When the image selection button is clicked, the first progress information transmission program captures an image taken subsequently, and lays it at a predetermined position in the progress information displaying form. In this, information of the time and date it was taken is also acquired from the PACS server 6 and laid in the progress information displaying form.

When the numerical data selecting button is clicked, the first progress information transmission program incorporates data directly from a monitoring device (e.g., blood pressure monitor) connected to the intranet 10, or inputs it on the primary terminal 1. The numerical data is laid at a predetermined position in the progress information displaying form. In this, the extraction time and date of the numerical data are acquired, and laid in the progress information displaying form.

When the medication selecting button is clicked, the first progress information transmission program makes the medication information (e.g., name and quantity of a administered medication, administration time and date) input on the primary terminal 1, and lays the input information at a predetermined position in the progress information displaying form.

Distribution of the progress information to each secondary terminal 2 is done by sending an E-mail from the communication server 3 to each secondary terminal 2 and embedding in the E-mail a command executing the progress information programs. Those E-mails urge the expert-physicians to download the progress information, by informing that it has been uploaded to the communication server 3. Those E-mails are hereinafter referred as “progress information reminder mails”. A form file for a progress information displaying form is stored in the storage of the communication server 3. The first progress information transmission program updates the progress information displaying form by laying therein the input progress information, stores the updated form file, and sends the progress information reminder mails for executing the second progress information transmission program. By this, the first progress information transmission program is ended.

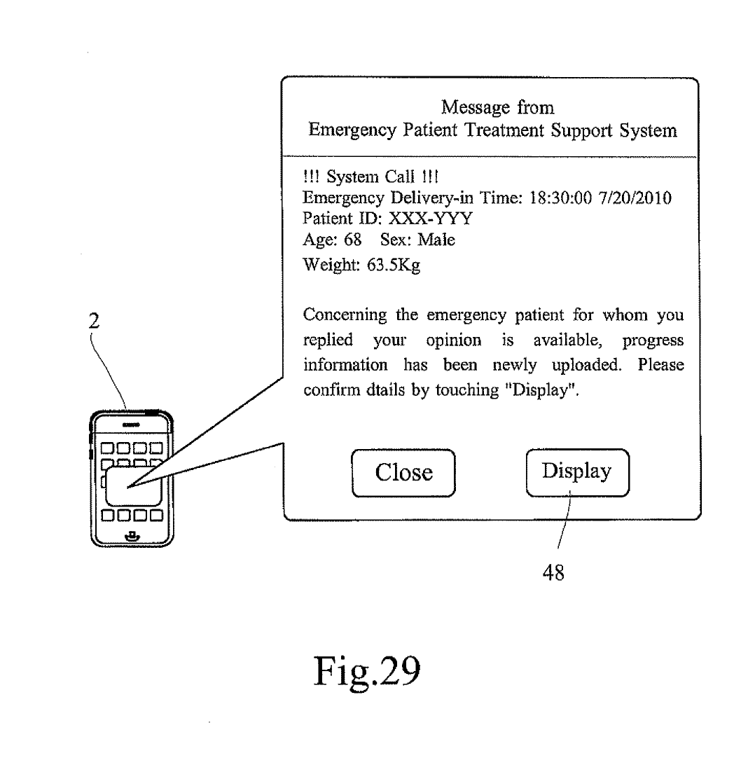

FIG. 29 roughly shows an example of the progress information reminder mail received on a secondary terminal 2. As shown on FIG. 29, the progress information reminder mail is the one where the support system notifies that a new piece of the progress information has been uploaded. A display button 48 is provided in the progress information reminder mail. A command to execute the second progress information transmission program is embedded in the display button 48. The second progress information transmission program reads out the progress information displaying form from the storage of the communication server 3, and transmits it to the secondary terminal 2 having accessed thereto.

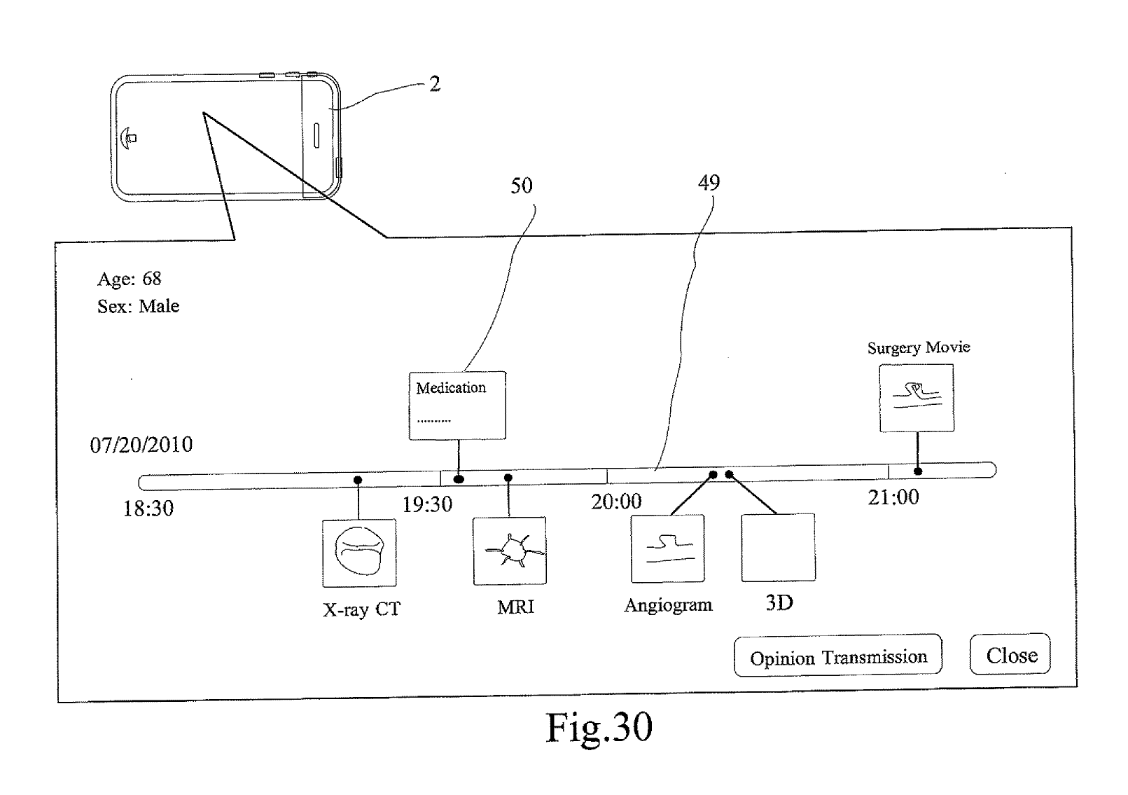

FIG. 30 roughly shows an example of the progress information displaying form received at a secondary terminal 2. As shown in FIG. 30, the progress information displaying form includes the time bar 49 showing the time elapsed and the time scale. In this example, the time bar 49 is horizontally placed. In this example, the secondary terminal 2 is supposed to be a smart phone, being held horizontal. As shown in FIG. 30, each piece of the progress information is displayed in a balloon 50 drawn from the time bar 49. Each position from which each balloon is drawn corresponds to the time for each piece of the progress information within each balloon, on the scale of the elapsed time shown by the time bar 49. As shown on FIG. 30, for example, the starting time on the time bar 49 is “2010/07/20 18:30” (i.e., eighteen thirty on Jul. 20, 2010), and marks are placed every thirty minutes on the time scale. If the progress information is a medication given at 19:35, this progress information is displayed in the balloon drawn from the position corresponding to 19:35 in the time scale expressed by the time bar 49.

On the progress information displaying form shown in FIG. 30, because the location and length of the time bar 49 is preset, it appears in a fixed position in the form. In inputting a piece of the progress information, an input box to designate the scale mark pitch on the time bar 49 is displayed on the primary terminal 1. By designating the scale mark pitch here, the first progress information transmission program presets the scale mark pitch of the time bar 49 as designated. With this, the program carries out a step of extracting the time information from the input piece of the progress information, a step of calculating the drawing position of the balloon for the input piece of the progress information, and a step of laying the input piece of the progress information in the balloon.

The processed progress information displaying form is stored in the storage of the communication server 3 under a filename using the case ID. In transmitting the progress information displaying form second time or more, the first progress information transmission program reads out the stored form and adds a new piece of progress information with a new balloon, and updates the form file. By the second progress information transmission program, the updated form is transmitted to the secondary terminal 2.

Recording of history information will be described next. The support system of this embodiment comprises a history recorder. As components of the history recorder, the support system comprises a recording server 5 and history information database file (hereinafter, “HI-DBF”) stored in a storage of the recording server 5. As shown in FIG. 6, a command button 59 with the title “Ending Management”, hereinafter, “management ending button”, is provided in the menu form. A management ending program is installed on the communication server 3. The management program is to end the management on the communication server 3 and leave an historical record on the recording server 5. By clicking the management ending button 59 on a primary terminal, a form to input the in-hospital physician ID and password is displayed thereon. If those are input correctly, a form for confirming management ending, hereinafter, “management ending confirmation form”, is displayed on the primary terminal 1.

The management ending program opens the temporary case DBF according to the input in-hospital physician ID, and displays a list of the information in the record(s) where the in-hospital physician ID is correspondent. This part is almost the same as on FIG. 20 and others. Although the list is usually of a line, it would be of multiple lines if the physician is in charge of multiple cases. A command button with the title “End” is automatically created and laid last in each line. This command button is to execute the management ending program with the case ID as argument.

The management ending program searches the temporary case DBF by using the case ID as search key, and cuts out the corresponding record. With that, all the information in the fields is stored to a memory variable, and the record is deleted from the temporary case DBF. Then the program adds a new record in the HI-DBF on the recording server 5, reads out the information from the memory variable, and records it in the added new record of the HI-DBF. The structure of the HI-DBF may be the same as of temporary case DBF.

Afterward, the management ending program cuts out the temporary receiver DBF for the case, according to the case ID. After storing the temporary receiver DBF to a memory variable, the program deletes it from the storage of the communication server 3. Then the program reads out the temporary receiver DBF from the memory variable, and stores it in the storage of the recording server 5. By this, the program is ended. The files in the storage of the recording server 5 are preserved permanently or for a predetermined long term. The recording server 5 has the role of the preservation place of the system usage history.

In the described support system of this embodiment, an opinion is preferably transmitted with an digital signature of the expert-physician who is sending it. E-mail transmissions with digital signatures are possible as regular functions in almost all mailers for desktop or notebook computers. Therefore, if a secondary terminal 2 is a desktop or notebook computer, it is utilized. To expert-physicians, it is requested in advance to transmit opinions with digital signatures.

As for mobile-type terminals, there are few types having functions of sending E-mails with digital signatures. The support system of this embodiment, therefore, comprises a special contrivance where retransmissions of opinions with digital signatures are requested to expert-physicians later on. As shown in FIG. 27, more concretely, a command button 61 with the title “Digital Signature Request”, hereinafter, “signature request button”, is provided in the opinion displaying form. A form file for a signature request form is stored in the storage of the communication server 3. By clicking the signature request button 61 on a primary terminal 1, the signature request form is displayed thereon. In the signature request button 61, there is an embedded program to search the temporary receiver DBF by using the expert-physician ID as search key, acquire the value in the field “Opinion” of the corresponding record, and lay it in the signature request form. In the EP-DBF, mail addresses from which E-mails with digital signatures can be transmitted have been registered. The program embedded in the signature request button 61 searches the EP-DBF by using the expert-physician ID as search key, and acquires the mail addresses.

A transmission button is provided in the signature request form. The acquired mail address is embedded in this transmission button. The signature request form includes a message that retransmission of the opinion, which is displayed for confirmation, with a digital signature is requested. By clicking the transmission button, the signature request form is transmitted to the mail addresses via E-mails. The expert-physicians reply to it, retransmitting the opinions with digital signatures. The communication server 3 comprises a program to check whether a digital signature is attached to an E-mail (e.g., the opinion mail and the above reply mail) transmitted from a secondary terminal 2, according to the header information of the E-mail. If a digital signature is attached, the program acquires the digital signature information therefrom and preserves it. The digital signature information can be preserved in a field named “Digital Signature Information”, which is provided in, for example, the temporary receiver DBF. Otherwise it can be preserved in another database file. The digital signature information, which includes a digital signature itself and information thereof, is preserved in the HI-DBF in the recordation server 5 as well as the opinions.

An alarmer will be described next. The support system of this embodiment comprises the alarmer to generating alarms when the initial disease data is transmitted from a primary terminal 1. The alarms are to inform the expert-physicians that the initial disease data has been transmitted, and prompts them to transmit their opinions. Because transmissions of the opinions are for a treatment of an emergency patient, those are is very urgent. If receipts of the initial disease data are not recognized, the opinions could not reach at adequate timings, resulting in that those could not be referred in deciding a treatment plan. Considering this, the support system comprises the alarmer. The alarmer is a means to generating alarms made of sound, light, vibration or any combination thereof.

In the support system of this embodiment, as described, the inquiry information and initial disease data are transmitted via E-mails. Therefore, the alarmer is the means to give notice of arrivals of the E-mails to the expert-physicians. Because almost all mailers currently used have functions of alarming arrivals of E-mails, those functions are used for the alarmer in this embodiment. It is requested in advance to the expert-physicians to preset the secondary terminals 2 so that the alarming functions can work.

If the inquiry information and initial disease data are not transmitted via E-mails, the alarmer has to be modified. For example, if the system is modified to be one where a secondary terminal 2 actively accesses the communication server 3 and acquires the initial disease data after it is transmitted from the primary terminal 1, the alarmer has to prompt the secondary terminal 2 to access the communication server 3. As an example for this, the alarmer may make a single ring call to each cell phone held by each expert-physician. That is, the alarm makes a call of single or several rings to each cell phone from a phone number allocated to this system. The calls are done under the condition that the caller number notification is valid, so that the caller number can be known as of the support system at the secondary terminals 2. Each cell phone number of each expert-physician is registered in the EP-DBF, and a program to make such calls in order is installed in the communication server 3.

In the described embodiment, the inquiry information and initial disease data may be transmitted via downloads from the communication server 3. In this case, an E-mail including a brief text as shown in FIG. 29 is transmitted as an alarm. A command button to access the communication server 3 is laid in the E-mail. By clicking the command button, the inquiry information or initial disease data including not only image but text is downloaded from the communication server 3. Therefore, a transmitter transmitting such an E-mail as shown in FIG. 29 can be an alarmer in the support system.

By the above-described support system of this embodiment, the initial disease data including an image is transmitted to multiple expert-physicians with the reply period thereto. Then the opinions based on reviewing the initial disease data are transmitted from the expert-physicians. Therefore, the physician in charge can establish a diagnosis and decide a treatment plan referring to the opinions. Accordingly, the probability that a more adequate treatment is performed increases, compared to the case the physician in charge does all that alone.

In addition, the inquiry information is transmitted to the expert-physicians before transmitting the initial disease data. The initial disease data is transmitted to only the expert-physicians who have replied that the opinion can be provided. Therefore, the initial disease data are not transmitted wastefully and indiscreetly to expert-physicians who cannot respond to. On the side of the expert-physicians, there is no uneasiness, because the initial disease data for a case to which he/she cannot commit is not reaching him/her. Because the initial disease data includes a diagnostic image, it is preferable to transmit it only to the expert-physicians having replied “available”, in view of the privacy information protection.

The support system of this embodiment can select the expert-physicians with a specific level of specialization, and transmit the initial disease data only to them. Therefore, provisions of opinions can be requested only to those expert-physicians with the adequate specialization level, considering the particularity of a disease, difficulty of diagnosis and treatment, and the like. Accordingly, it leads to obtaining much more adequate opinions, which contributes to a much more adequate treatment.

Moreover, because the support system of this embodiment comprises the real-time communicator, it is possible that many of the expert-physicians provide their comments on one emergency disease or one opinion, thereby making a discussion. Therefore, it is possible to reach a more adequate conclusion by accumulating many comments and opinions on the disease, which enables a more adequate treatment.

Because the support system of this embodiment comprises the progress information transmitter, it is possible to request an additional opinion depending on a situation after transmitting the initial disease data. Therefore, a more adequate treatment is enabled in this respect. In this, because the progress information is displayed time-related on a secondary terminal 2 with the time bar showing all events in the established time-frame, it is possible for the expert-physicians to know easily the evolution of diagnosis and treatment in time. Therefore, opinions can be provided with more adequate timings in the treatment of the emergency disease, which is the “battle against time”.

Moreover, the support system of this embodiment comprises the image restructurer which enables the expert-physicians to freely restructure an image by themselves. Therefore, they can give their opinions more adequately reviewing the restructured image. In the HI-DBF on the recording server 5, this support system records and preserves the fact that opinions were requested transmitting an initial disease data as well as provided opinion(s). The preserved information can be utilized later on as evidences showing a treatment was done adequately. That is, if it is questioned whether the diagnosis and treatment plan were adequate (e.g., if any malpractice lawsuit is brought), the hospital can reply by asserting that opinions were requested appropriately to the expert-physicians on the basis of the initial disease data, and that the diagnosis and treatment were accomplished according to the provided opinion(s). In this defense, because this system receives an opinion with a digital signature, and the opinion is preserved in the history information file with the digital signature, credibility i.e., evidential value, for the receipt and contents of the opinion can be enhanced. The system has advantage in this respect.

In the described support system, an image transmitted form the communication server 3 may be a movie taken during a surgery. For example, a movie taken during a surgery could be transmitted to the secondary terminals 2 in real time as the progress information. The streaming distribution technique is used for this real time transmission. Otherwise an Internet video phone service can be used. Therefore, detailed description is omitted. A form in which a surgical movie is displayed may include a command button to transmit an opinion. An expert-physician clicks the button and transmits the opinion when he/she notices anything to comment on the movie. A surgical movie may be transmitted as the initial disease data. For example, the inquiry information is transmitted to expert-physicians when starting a surgery. In this inquiry, it is informed in advance that a surgical movie will be transmitted, and each expert-physician is asked to provide his/her opinion while watching the movie.

In the described support system, it is preferable that the progress information is transmitted not only to the secondary terminals 2 but to other primary terminals 1 in the hospital. In a situation where several physicians and nurses are in charge of an emergency disease treatment as a team, for example, each member of the team carries a mobile-type primary terminal 1. When any progress information takes place, it is transmitted to each primary terminal 1 in the team immediately. By this, the progress information can be shared by all members of the team in real time. This enables that the diagnosis and treatment of the emergency disease are performed faster and more effectively.

In the description of this embodiment, although cerebrovascular diseases such as cerebral infarction and cerebral hemorrhage were taken as examples, the invention can be used for supporting treatments of diseases in other clinical fields. For example, the invention can be used for cardiovascular diseases such as myocardial infarction and aortic aneurysm. The invention also can be used for an emergency such as injury (e.g., by a traffic accident), and for an obstetric emergency, such as imminent premature birth and perinatal cerebral hemorrhage.

What is claimed:

1. A support system for a treatment of an emergency patient in a hospital; comprising
a database server including an expert-physician database file in which information of expert-physicians belonging to institutions other than the hospital is recorded, the expert-physicians being recognized as those having special knowledge and experience in specific clinical fields of diseases;
a recorder to record the information of the expert-physicians in the expert-physician database file;
a primary terminal handled by a physician in charge of treating the emergency patient in the hospital;
each secondary terminal handled by each expert-physician, the information recorded in the expert-physician database file including addresses of the secondary terminals;
a primary transmitter for transmitting an initial disease data to each secondary terminal, the initial disease data including a disease image of the emergency patient and time when the image was taken;
a received information displayer to display the initial disease data on each secondary terminal after the initial disease data is received thereon;
a secondary transmitter to transmit an opinion to the primary terminal, the opinion being input by one of the expert-physicians on one of the primary terminals;
an opinion displayer to display the opinion on the primary terminal after the opinion is received thereon, and
an alarmer to generate an alarm by sound, light, vibration or any combination thereof to each expert-physician when the initial disease data is transmitted to each secondary terminal;
wherein
the opinion is concerning to necessity of an additional test and investigation for the emergency patient, a diagnosis for the emergency patient, or a treatment plan for the emergency patient, and
the primary transmitter transmits the initial disease data with a time period for transmitting the opinion.

2. A support system for a treatment of an emergency patient in a hospital, as claimed in the claim 1,
further comprising
an inquiry information transmitter making inquiry information input on the primary terminal and transmitted to each secondary terminal, the inquiry information including a text about an initial observation of the emergency patient; and
an availability information transmitter transmitting availability information from one or more secondary terminals to the primary terminal, the availability information being about availability to provide the opinion within the reply period, and being input on the one or more secondary terminals after the inquiry information is received thereon;
wherein
the initial transmitter makes the initial disease data reach to only the secondary terminals from which the availability information as the opinion is available to be provided within the reply period has been transmitted.

3. A support system for a treatment of an emergency patient in a hospital, as claimed in the claim 1,
wherein
the information of the expert-physicians includes a specialization level for each expert-physician;
the initial transmitter is capable of transmitting the initial disease data to only the secondary terminals handled by the expert-physicians selected according to the specialization level.

4. A support system for a treatment of an emergency patient in a hospital, as claimed in the claim 1,
further comprising a communication server,
wherein
the secondary transmitter transmits the opinion to the primary terminal via the communication server;
the communication server comprises a real time communication program,
the real time communication program
makes a group of the secondary terminals to which the initial disease data has been sent,
forwards the opinion sent from one of the secondary terminals to other secondary terminals of the group in addition to the primary terminal, and
forwards a comment on the opinion from one of the terminal of the group to the other terminals thereof.

5. A support system for a treatment of an emergency patient in a hospital, as claimed in the claim 1,
further comprising
a progress information transmitter transmitting progress information to each secondary terminal after transmitting the initial disease data, the progress information concerning to a subsequent condition of the patient, an additional test and investigation for the emergency patient, a diagnosis for the emergency patient, or a treatment of the emergency patient, after transmitting the initial disease data.

6. A support system for a treatment of an emergency patient in a hospital, as claimed in the claim 1,
wherein
the progress information includes time information for the condition of the patient, the additional test and investigation for the emergency patient, the diagnosis for the emergency patient or the treatment of the emergency patient, after transmitting the initial disease data,
the progress information transmitter transmits the progress information so that the progress information is displayed with a time bar on each secondary terminal, the time bar being a line showing a time elapsed from an onset of the disease of the emergency patient.

7. A support system for a treatment of an emergency patient in a hospital, as claimed in the claim 1,
wherein
the image in the initial disease data is a movie, and
the initial transmitter transmits the movie in real time to each secondary terminal while the movie of the diseased part is taken by imaging equipment.

8. A support system for a treatment of an emergency patient in a hospital, as claimed in the claim 5,
wherein
the progress information includes a movie, and
the progress information transmitter transmits the movie in real time to each secondary terminal while the movie is taken by imaging equipment.

9. A support system for a treatment of an emergency patient in a hospital, as claimed in the claim 7,
wherein the movie is taken during a surgery of the emergency patient.

10. A support system for a treatment of an emergency patient in a hospital, as claimed in the claim 8,
wherein the movie is taken during a surgery of the emergency patient.

11. A support system for a treatment of an emergency patient in a hospital, as claimed in the claim 1,
further comprising
an image restructurer restructuring the image displayed on one of the secondary terminals, and
an image restructuring program as a component of the image restructurer,
wherein the image is obtained by processing an output of imaging equipment,
the image restructuring program is executed by the one of the secondary terminal displaying the image, and restructures the image by carrying out a different data processing of the output of the imaging equipment.

12. A support system for a treatment of an emergency patient in a hospital, as claimed in the claim 1,
further comprising
a history recorder,
a recordation sever as a component of the history recorder, the recordation server having a storage, and
a history information file stored in the storage of the recordation server,
wherein
the history recorder records receipt of the opinion from the one of the secondary terminals and the opinion in the history information file, as well as transmission of the initial disease data to each secondary terminal.

13. A support system for a treatment of an emergency patient in a hospital, as claimed in the claim 12,
wherein
the secondary transmitter transmits the opinion with a digital signature of the expert-physician transmitting the opinion, and
the history recorder records the opinion with the digital signature in the history information file.
